(19) United States
(12) Patent Application Publication
(10) Pub. No.: US 2013/0343059 A1
(43) Pub. Date: Dec. 26, 2013

(54) PHOSPHOR AND LIGHT EMITTING DEVICE

(71) Applicants: Daichi Usui, Yokohama-Shi (JP); Yasuhiro Shirakawa, Yokohama-Shi (JP); Hirofumi Takemura, Kamakura-Shi (JP)

(72) Inventors: Daichi Usui, Yokohama-Shi (JP); Yasuhiro Shirakawa, Yokohama-Shi (JP); Hirofumi Takemura, Kamakura-Shi (JP)

(73) Assignees: TOSHIBA MATERIALS CO., LTD., Yokohama-Shi, Kanagawa-Ken (JP); KABUSHIKI KAISHA TOSHIBA, Tokyo (JP)

(21) Appl. No.: 13/985,618

(22) PCT Filed: Feb. 29, 2012
(86) PCT No.: PCT/JP2012/055120

§ 371 Date: Aug. 15, 2013

(30) Foreign Application Priority Data
Mar. 17, 2011 (JP) 2011 059488

(51) Int. Cl. C09K 11/77; F21K 99/00

(52) U.S. Cl. CPC C09K 11/7731; F21K 9/56
USPC 362/293; 252/301.4 F

(57) ABSTRACT

The present invention provides a phosphor comprising a europium-activated sialon crystal having a basic composition represented by the following formula (1)

[Formula 1]

formula: (Sr₁₋ₓ, Euₓ)_{α}Si_{β}Al_{γ}O_{δ}N_{ω} (1)

(wherein x is 0<x<1, α is 0<α≦4 and β, γ, δ and ω are numbers such that converted numerical values when α is 3 satisfy 9<β≦15, 1≦γ≦5, 0.5≦δ≦3 and 10≦ω≦25), and the sialon crystal includes at least one non-Eu rare earth element selected from Sc, Y, La, Ce, Pr, Nd, Sm, Gd, Tb, Dy, Ho, Er, Tm, Yb and Lu in a proportion of 0.1% by mass or more and 10% by mass or less, and the phosphor emitting green light by being excited by ultraviolet light, violet light or blue light.

### TECHNICAL FIELD

Embodiments of the present invention relate to a phosphor and a light emitting device.

### BACKGROUND ART

Phosphor powders are used, for example, for light emitting devices such as light emitting diodes (LEDs). Light emitting devices comprise, for example, a semiconductor light emitting element which is arranged on a substrate and emits light of a pre-determined color, and a light emitting portion containing a phosphor powder in a cured transparent resin, that is, an encapsulating resin. The phosphor powder contained in the light emitting portion emits visible light by being excited by ultraviolet light or blue light emitted from the semiconductor light emitting element.

Examples of the semiconductor light emitting element used in a light emitting device include GaN, InGaN, AlGaN and InGaAlP. Examples of the phosphor of the phosphor powder used include a blue phosphor, a green phosphor, a yellow phosphor and a red phosphor, which emit blue light, green light, yellow light and red light, respectively, by being excited by the light emitted from the semiconductor light emitting element.

In light emitting devices, the color of the radiation light can be adjusted by including various phosphor powders such as a red phosphor in an encapsulating resin. More specifically, using in combination a semiconductor light emitting element and a phosphor powder which absorbs light emitted from the semiconductor light emitting element and emits light of a predetermined wavelength range causes action between the light emitted from the semiconductor light emitting element and the light emitted from the phosphor powder, and the action enables emission of light of a visible light region or white light.

In the past, a phosphor containing strontium and having a europium-activated sialon (Si—Al—O—N) structure (Sr sialon phosphor) has been known.

### CITATION LIST

### Patent Document

Patent Document 1: International Publication No. 2007/105631

### SUMMARY OF INVENTION

### Problems to be Solved by the Invention

Recently, however, a Sr sialon phosphor having higher luminous efficiency has been requested.

The present invention has been made under the above circumstances, and an object thereof is to provide a Sr sialon phosphor and a light emitting device with high luminous efficiency.

### Means for Solving the Problems

A phosphor and a light emitting device according to the embodiment have been accomplished based on the finding that including a specific non-Eu rare earth element in a Sr sialon phosphor having a specific composition at a specific ratio increases the luminous efficiency of the Sr sialon phosphor.

A phosphor according to the embodiment solves the above problem and comprises a europium-activated sialon crystal having a basic composition represented by the following formula (1)

[Formula 1]

formula: (Sr₁₋ₓ, Euₓ)_{α}Si_{β}Al_{γ}O_{δ}N_{ω} (1)

(wherein x is 0<x<1, α is 0<α≦4 and β, γ, δ and ω are numbers such that the converted numerical values when α is 3 satisfy 9<β≦15, 1≦γ≦5, 0.5≦β≦3 and 10≦ω≦25),

and the sialon crystal includes at least one non-Eu rare earth element selected from Sc, Y, La, Ce, Pr, Nd, Sm, Gd, Tb, Dy, Ho, Er, Tm, Yb and Lu in a proportion of 0.1% by mass or more and 10% by mass or less, and the phosphor emits green light by being excited by ultraviolet light, violet light or blue light.

Further, a phosphor according to the embodiment solves the above problem and comprises a europium-activated sialon crystal having a basic composition represented by the following formula (2)

[Formula 2]

formula: (Sr₁₋ₓ, Euₓ)_{α}Si_{β}Al_{γ}O_{δ}N_{ω} (2)

(wherein x is 0<x<1, α is 0<α≦3 and β, γ, δ and ω are numbers such that the converted numerical values when α is 2 satisfy 5≦β≦9, 1≦γ≦5, 0.5≦δ≦2 and 5≦ω≦15),

and the sialon crystal includes at least one non-Eu rare earth element selected from Sc, Y, La, Ce, Pr, Nd, Sm, Gd, Tb, Dy, Ho, Er, Tm, Yb and Lu in a proportion of 0.1% by mass or more and 10% by mass or less, and the phosphor emits red light by being excited by ultraviolet light, violet light or blue light.

Furthermore, a light emitting device according to the embodiment solves the above problem and comprises a substrate, a semiconductor light emitting element which is arranged on the substrate and emits ultraviolet light, violet light or blue light, and a light emitting portion which is formed so as to cover a light emitting surface of the semiconductor light emitting element and contains a phosphor which emits visible light by being excited by light emitted from the semiconductor light emitting element, wherein the phosphor includes the phosphor defined in any one of claims 1 to 6.

### Advantage of the Invention

The phosphor and the light emitting device of the present invention show high luminous efficiency.

### BRIEF DESCRIPTION OF THE DRAWINGS

FIG. 1 illustrates an example of an emission spectrum of a light emitting device.

FIG. 2 illustrates another example of an emission spectrum of a light emitting device.

### MODE FOR CARRYING OUT THE INVENTION

A phosphor and a light emitting device of the embodiment will be described. The phosphor of the embodiment includes a green phosphor which emits green light by being excited by ultraviolet light, violet light or blue light and a red phosphor which emits red light by being excited by ultraviolet light, violet light or blue light.

### [Green Phosphor]

The green phosphor comprises a europium-activated sialon crystal having a basic composition represented by the following formula (1)

[Formula 3]

formula: (Sr₁₋ₓ, Euₓ)_{α}Si_{β}Al_{γ}O_{δ}N_{ω} (1)

(wherein x is 0<x<1, α is 0<α≦4 and β, γ, δ and ω are numbers such that the converted numerical values when α is 3 satisfy 9<β≦15, 1≦γ≦5, 0.5≦δ≦3 and 10≦ω≦25),

and emits green light by being excited by ultraviolet light, violet light or blue light. This green light emitting phosphor is also referred to as a “Sr sialon green phosphor” below.

In the Sr sialon green phosphor, the europium-activated sialon crystal having a basic composition represented by the formula (1) has a composition represented by the formula (1) and at the same time includes at least one non-Eu rare earth element which is not represented by the formula (1) and is selected from Sc, Y, La, Ce, Pr, Nd, Sm, Gd, Tb, Dy, Ho, Er, Tm, Yb and Lu.

Here, the relationship between the europium-activated sialon crystal having a basic composition represented by the formula (1) and the Sr sialon green phosphor will be described.

The europium-activated sialon crystal having a basic composition represented by the formula (1) is an orthorhombic single crystal. The europium-activated sialon crystal contains a non-Eu rare earth element.

On the other hand, the Sr sialon green phosphor is a crystalline body composed of one europium-activated sialon crystal having a basic composition represented by the formula (1), or an aggregate of crystals in which two or more of the europium-activated sialon crystals are aggregated.

The non-Eu rare earth element is present in the europium-activated sialon crystal and not attached to the surface of the europium-activated sialon crystal. Therefore, even if the Sr sialon green phosphor is an aggregate of many europium-activated sialon crystals, the content of the non-Eu rare earth element in the Sr sialon green phosphor and the content of the non-Eu rare earth element in the europium-activated sialon crystal are substantially the same. However, the Sr sialon green phosphor is generally in the form of single crystal powder.

When the Sr sialon green phosphor is an aggregate of crystals in which two or more of the europium-activated sialon crystals are aggregated, the respective europium-activated sialon crystals can be separated by cracking.

In the formula (1), x is a number that satisfies 0<x<1, preferably 0.025≦x≦0.5, and more preferably 0.25≦x≦0.5.

When x is 0, the baked body prepared in the baking step is not a phosphor. When x is 1, the Sr sialon green phosphor has low luminous efficiency.

Further, the smaller the x is in the range of 0<x<1, the more likely the luminous efficiency of the Sr sialon green phosphor is to decrease. Furthermore, the larger the x is in the range of 0<x<1, the more likely the concentration quenching occurs due to an excess Eu concentration.

Therefore, in 0<x<1, x is a number that satisfies preferably 0.025≦x≦0.5, and more preferably 0.25≦x≦0.5.

In the formula (1), the comprehensive index of Sr, (1-x)α, represents a number that satisfies 0<(1-x)α<4. Further, the comprehensive index of Eu, xα, represents a number that satisfies 0<xα<4. In other words, in the formula (1), the comprehensive indices of Sr and Eu represent a number of more than 0 and less than 4, respectively.

In the formula (1), α represents the total amount of Sr and Eu. By defining the numerical values of β, γ, δ and ω when the total amount α is a constant value 3, the ratio of α, β, γ, δ and ω in the formula (1) is clearly determined.

In the formula (1), β, γ, δ and ω represent a numerical value converted when α is 3.

In the formula (1), the index of Si, β, is a number such that the numerical value converted when α is 3 satisfies 9<β≦15.

In the formula (1), the index of Al, γ, is a number such that the numerical value converted when α is 3 satisfies 1≦γ≦5.

In the formula (1), the index of O, δ, is a number such that the numerical value converted when α is 3 satisfies 0.5≦δ≦3.

In the formula (1), the index of N, ω, is a number such that the numerical value converted when α is 3 satisfies 10≦ω≦25.

When the indices β, γ, δ and ω in the formula (1) are out of the respective ranges, the composition of the phosphor prepared by baking is likely to be different from that of the orthorhombic Sr sialon green phosphor represented by the formula (1).

In the Sr sialon green phosphor, the europium-activated sialon crystal having a basic composition represented by the formula (1) includes at least one non-Eu rare earth element selected from Sc, Y, La, Ce, Pr, Nd, Sm, Gd, Tb, Dy, Ho, Er, Tm, Yb and Lu in a proportion of 0.1% by mass or more and 10% by mass or less, preferably 0.5% by mass or more and 5% by mass or less, and more preferably 0.7% by mass or more and 2% by mass or less.

Here, the content of the non-Eu rare earth element means a ratio of the mass of the non-Eu rare earth element to the mass of the entire europium-activated sialon crystal containing the non-Eu rare earth element.

When the content of the non-Eu rare earth element is within the above range, the growth of the crystal of the Sr sialon green phosphor at baking is facilitated and allows the baking time of the Sr sialon green phosphor to be reduced compared to the case where the content of the non-Eu rare earth element is out of the above range. At the same time, since the Sr sialon green phosphor has good crystalline properties and the crystals of the Sr sialon green phosphor become dense, and as a result the Sr sialon green phosphor has higher luminous efficiency. Here, good crystalline properties mean that there are few lattice defects.

On the other hand, when the content of the non-Eu rare earth element is less than 0.1% by mass or more than 10% by mass, it is likely that the Sr sialon green phosphor has poor crystalline properties and therefore the Sr sialon green phosphor has low luminous efficiency.

It is preferable that in the Sr sialon green phosphor, the europium-activated sialon crystal includes at least Y as a non-Eu rare earth element, the Sr sialon green phosphor has improved crystalline properties and therefore the Sr sialon green phosphor has high luminous efficiency.

Further, in the Sr sialon green phosphor, it is more preferable that the europium-activated sialon crystal includes Y and a non-Eu rare earth element such as Sc, La, Ce, Pr, Nd, Sm, Gd, Tb, Dy, Ho, Er, Tm, Yb and Lu, the Sr sialon green phosphor has further improved crystalline properties and therefore the Sr sialon green phosphor has higher luminous efficiency.

The Sr sialon green phosphor is generally in the form of single crystal powder. The form of single crystal powder is the state that the particles constituting the powder are single crystal particles.

The Sr sialon green phosphor powder has an average particle size of generally 1 μm or more and 100 μm or less, preferably 5 μm or more and 80 μm or less, more preferably 8 μm or more and 80 μm or less, and further preferably 8 μm or more and 40 μm or less. Here, the average particle size means a measured value by a Coulter counter method, which is the median D₅₀ in volume cumulative distribution.

When the Sr sialon green phosphor powder has an average particle size of less than 1 μm or more than 100 μm, extraction efficiency of light from a light emitting device is likely to be decreased in the case where the Sr sialon green phosphor powder or a phosphor powder of a different color is dispersed in a cured transparent resin to prepare a light emitting device designed to emit green or different color light by the irradiation of ultraviolet light, violet light or blue light from a semiconductor light emitting element.

The Sr sialon green phosphor represented by the formula (1) is excited by the irradiation of ultraviolet light, violet light or blue light and emits green light.

Here, the ultraviolet light, violet light or blue light means light having a peak wavelength in the wavelength range of ultraviolet, violet or blue light. It is preferable that the ultraviolet light, violet light or blue light have a peak wavelength in the range of 370 nm or more and 470 nm or less.

The Sr sialon green phosphor represented by the formula (1) excited by receiving ultraviolet light, violet light or blue light emits green light with an emission peak wavelength of 500 nm or more and 540 nm or less.

### [Red Phosphor]

The red phosphor comprises a europium-activated sialon crystal having a basic composition represented by the following formula (2)

[Formula 4]

formula: (Sr₁₋ₓ, Euₓ)_{α}Si_{β}Al_{γ}O_{δ}N_{ω} (2)

(wherein x is 0<x<1, α is 0<α≦3 and β, γ, δ and ω are numbers such that the converted numerical values when α is 2 satisfy 5≦β≦9, 1≦γ≦5, 0.5≦δ≦2 and 5≦ω≦15),

and emits red light by being excited by ultraviolet light, violet light or blue light. This red light emitting phosphor is also referred to as a “Sr sialon red phosphor” below.

In the Sr sialon red phosphor, the europium-activated sialon crystal having a basic composition represented by the formula (2) has a composition represented by the formula (2) and at the same time includes at least one non-Eu rare earth element which is not represented by the formula (2) and is selected from Sc, Y, La, Ce, Pr, Nd, Sm, Gd, Tb, Dy, Ho, Er, Tm, Yb and Lu.

Here, the relationship between the europium-activated sialon crystal having a basic composition represented by the formula (2) and the Sr sialon red phosphor will be described.

The europium-activated sialon crystal having a basic composition represented by the formula (2) is an orthorhombic single crystal. The europium-activated sialon crystal contains a non-Eu rare earth element.

On the other hand, the Sr sialon red phosphor is a crystalline body composed of one europium-activated sialon crystal having a basic composition represented by the formula (2), or an aggregate of crystals in which two or more of the europium-activated sialon crystals are aggregated.

The non-Eu rare earth element is present in the europium-activated sialon crystal and not attached to the surface of the europium-activated sialon crystal. Therefore, even if the Sr sialon red phosphor is an aggregate of many europium-activated sialon crystals, the content of the non-Eu rare earth element in the Sr sialon red phosphor and the content of the non-Eu rare earth element in the europium-activated sialon crystal are substantially the same. However, the Sr sialon red phosphor is generally in the form of single crystal powder.

When the Sr sialon red phosphor is an aggregate of crystals in which two or more of the europium-activated sialon crystals are aggregated, the respective europium-activated sialon crystals can be separated by cracking.

In the formula (2), x is a number that satisfies 0<x<1, preferably 0.025≦x≦0.5, and more preferably 0.25≦x≦0.5.

When x is 0, the baked body prepared in the baking step is not a phosphor. When x is 1, the Sr sialon red phosphor has low luminous efficiency.

Further, the smaller the x is in the range of 0<x<1, the more likely the luminous efficiency of the Sr sialon red phosphor is to decrease. Furthermore, the larger the x is in the range of 0<x<1, the more likely the concentration quenching occurs due to an excess Eu concentration.

Therefore, in 0<x<1, x is a number that satisfies preferably 0.025≦x≦0.5, and more preferably 0.25≦x≦0.5.

In the formula (2), the comprehensive index of Sr, (1-x)α, represents a number that satisfies 0<(1-x)α<3. Further, the comprehensive index of Eu, xα, represents a number that satisfies 0<xα<3. In other words, in the formula (2), the comprehensive indices of Sr and Eu represent a number of more than 0 and less than 3, respectively.

In the formula (2), α represents the total amount of Sr and Eu. By defining the numerical values of β, γ, δ and ω when the total amount α is a constant value 2, the ratio of α, β, γ, δ and ω in the formula (2) is clearly determined.

In the formula (2), β, γ, δ and ω represent a numerical value converted when α is 2.

In the formula (2), the index of Si, β, is a number such that the numerical value converted when α is 2 satisfies 5<β≦9.

In the formula (2), the index of Al, γ, is a number such that the numerical value converted when α is 2 satisfies 1≦γ≦5.

In the formula (2), the index of O, δ, is a number such that the numerical value converted when α is 2 satisfies 0.5≦δ≦2.

In the formula (2), the index of N, ω, is a number such that the numerical value converted when α is 2 satisfies 5≦ω≦15.

When the indices β, γ, δ and ω in the formula (2) are out of the respective ranges, the composition of the phosphor prepared by baking is likely to be different from that of the orthorhombic Sr sialon red phosphor represented by the formula (2).

In the Sr sialon red phosphor, the europium-activated sialon crystal having a basic composition represented by the formula (2) includes at least one non-Eu rare earth element selected from Sc, Y, La, Ce, Pr, Nd, Sm, Gd, Tb, Dy, Ho, Er, Tm, Yb and Lu in a proportion of 0.1% by mass or more and 10% by mass or less, preferably 0.5% by mass or more and 5% by mass or less, and more preferably 0.7% by mass or more and 2% by mass or less.

Here, the content of the non-Eu rare earth element means a ratio of the mass of the non-Eu rare earth element to the mass of the entire europium-activated sialon crystal containing the non-Eu rare earth element.

When the content of the non-Eu rare earth element is within the above range, the growth of the crystal of the Sr sialon red phosphor at baking is facilitated and allows the baking time of the Sr sialon red phosphor to be reduced compared to the case where the content of the non-Eu rare earth element is out of the above range. At the same time, due to good crystalline properties of the Sr sialon red phosphor, the Sr sialon red phosphor has higher luminous efficiency. Here, good crystalline properties mean that there are few lattice defects.

On the other hand, when the content of the non-Eu rare earth element is less than 0.1% by mass or more than 10% by mass, it is likely that the Sr sialon red phosphor has poor crystalline properties and therefore the Sr sialon red phosphor has low luminous efficiency.

It is preferable that in the Sr sialon red phosphor, the europium-activated sialon crystal includes at least Y as a non-Eu rare earth element, the Sr sialon red phosphor has improved crystalline properties and therefore the Sr sialon red phosphor has high luminous efficiency.

Further, in the Sr sialon red phosphor, it is more preferable that the europium-activated sialon crystal includes Y and a non-Eu rare earth element such as Sc, La, Ce, Pr, Nd, Sm, Gd, Tb, Dy, Ho, Er, Tm, Yb and Lu, the Sr sialon red phosphor has further improved crystalline properties and therefore the Sr sialon red phosphor has higher luminous efficiency.

The Sr sialon red phosphor is generally in the form of single crystal powder. The form of single crystal powder is the state that the particles constituting the powder are single crystal particles.

The Sr sialon red phosphor powder has an average particle size of preferably 1 μm or more and 100 μm or less, more preferably 5 μm or more and 50 μm or less, and further preferably 10 μm or more and 35 μm or less. Here, the average particle size means a measured value by a Coulter counter method, which is the median D₅₀ in volume cumulative distribution.

When the Sr sialon red phosphor powder has an average particle size of less than 1 μm or more than 100 μm, extraction efficiency of light from a light emitting device is likely to be decreased in the case where the Sr sialon red phosphor powder or a phosphor powder of a different color is dispersed in a cured transparent resin to prepare a light emitting device designed to emit red or different color light by the irradiation of ultraviolet light, violet light or blue light from a semiconductor light emitting element.

The Sr sialon red phosphor represented by the formula (2) is excited by receiving ultraviolet light, violet light or blue light and emits red light.

Here, the ultraviolet light, violet light or blue light means light having a peak wavelength in the wavelength range of ultraviolet, violet or blue light. It is preferable that the ultraviolet light, violet light or blue light have a peak wavelength in the range of 370 nm or more and 470 nm or less.

The Sr sialon red phosphor represented by the formula (2) excited by receiving ultraviolet light, violet light or blue light emits red light with an emission peak wavelength of 550 nm or more and 650 nm or less.

### [Method for Producing Green Phosphor and Red Phosphor]

The Sr sialon green phosphor represented by the formula (1) and the Sr sialon red phosphor represented by the formula (2) can be produced by, for example, preparing a mixture of phosphor raw materials by dry mixing raw materials such as strontium carbonate SrCO₃, aluminum nitride AlN, silicon nitride Si₃N₄, europium oxide Eu₂O₃ and oxide of a non-Eu rare earth element, and baking the mixture of phosphor raw materials in nitrogen atmosphere.

The Sr sialon green phosphor represented by the formula (1) contains more nitrogen N than the Sr sialon red phosphor represented by the formula (2). Therefore, the Sr sialon green phosphor represented by the formula (1) and the Sr sialon red phosphor represented by the formula (2) can be prepared separately by changing the blending ratio of raw materials such as SrCO₃, AlN, Si₃N₄, Eu₂O₃ and oxide of a non-Eu rare earth element in the mixture of phosphor raw materials, or changing the amount of nitrogen gas in the oven at the time of baking. For example, when the pressure of nitrogen gas in the oven at the time of baking is set lower by about 1 atmosphere, the Sr sialon red phosphor represented by the formula (2) is likely to be prepared, and when the pressure is set higher by about 7 atmosphere, the Sr sialon green phosphor represented by the formula (1) is likely to be prepared.

The mixture of phosphor raw materials may further contain a flux agent. Examples of the flux agent include alkali metal fluoride such as potassium fluoride and alkali earth metal fluoride, which are a reaction accelerator, and strontium chloride SrCl₂.

The mixture of phosphor raw materials flux agent is charged in a refractory crucible. Examples of the refractory crucible used include a boron nitride crucible and a carbon crucible.

The mixture of phosphor raw materials in the refractory crucible is baked. A baking apparatus that can maintain predetermined conditions of the composition and the pressure of the baking atmosphere, the baking temperature and the baking time in the inside where the refractory crucible is placed is used. Examples of such a baking apparatus used include an electric oven.

Inert gas is used as the baking atmosphere. Examples of the inert gas used include N₂ gas, Ar gas and a mixed gas of N₂ and H₂.

Generally, when a phosphor powder is prepared by baking a mixture of phosphor raw materials, a phosphor powder of a pre-determined composition is prepared by elimination of an appropriate amount of oxygen O from the mixture of phosphor raw materials containing an excess amount of oxygen O compared to the composition of the phosphor powder.

N₂ in the baking atmosphere functions to eliminate an appropriate amount of oxygen O from the mixture of phosphor raw materials when a phosphor powder is prepared by baking the mixture of phosphor raw materials.

Ar in the baking atmosphere functions to prevent excess oxygen O from being supplied to the mixture of phosphor raw materials when a phosphor powder is prepared by baking the mixture of phosphor raw materials.

H₂ in the baking atmosphere functions as a reducing agent and eliminates more oxygen O from the mixture of phosphor raw materials than N₂ when a phosphor powder is prepared by baking the mixture of phosphor raw materials.

Therefore, when inert gas contains H₂, the baking time can be reduced compared to the case where the inert gas does not contain H₂. However, when the content of H₂ in inert gas is too high, the resulting phosphor powder is likely to have a composition different from that of the Sr sialon green phosphor represented by the formula (1) or the Sr sialon red phosphor represented by the formula (2), and therefore the phosphor powder is likely to have low emission intensity.

When the inert gas is N₂ gas or a mixed gas of N₂ and H₂, the inert gas has a molar ratio of N₂ to H₂, N₂:H₂, of generally 10:0 to 1:9, preferably 8:2 to 2:8, and more preferably 6:4 to 4:6.

When the inert gas has a molar ratio of N₂ to H₂ within the above range, that is, generally 10:0 to 1:9, a high quality single crystal phosphor powder with few defects in the crystal structure can be prepared by short-time baking.

The molar ratio of N₂ to H₂ in the inert gas can be set at the above ratio, that is, generally 10:0 to 1:9, by supplying N₂ and H₂ that are continuously supplied to the chamber of a baking apparatus so that the ratio of the flow rate of N₂ to that of H₂ is at the above ratio, and by continuously discharging the mixed gas in the chamber.

It is preferable that the inert gas which is the baking atmosphere be allowed to flow so as to form a stream in the chamber of a baking apparatus because the raw materials can be homogeneously baked.

The inert gas which is the baking atmosphere has a pressure of generally 0.1 MPa (about 1 atm) to 1.0 MPa (about 10 atm), preferably 0.4 MPa to 0.8 MPa.

When the pressure of the baking atmosphere is less than 0.1 MPa, the phosphor powder prepared by baking is likely to have a composition different from that of the Sr sialon green phosphor represented by the formula (1) or the Sr sialon red phosphor represented by the formula (2), as compared to the mixture of phosphor raw materials put in a crucible before baking. Therefore, the phosphor powder is likely to have low emission intensity.

When the pressure of the baking atmosphere is more than 1.0 MPa, the baking conditions are not very different from those in the case where the pressure is 1.0 MPa or less, and this results in waste of energy and is not preferable.

The baking temperature is generally 1400° C. to 2000° C., preferably 1750° C. to 1950° C., more preferably 1800° C. to 1900° C.

When the baking temperature is in the range of 1400° C. to 2000° C., a high quality single crystal phosphor powder with few defects in the crystal structure can be prepared by short-time baking.

When the baking temperature is less than 1400° C., it is likely that the color of light emitted from the obtained phosphor powder when excited by ultraviolet light, violet light or blue light is not a desired one. More specifically, it is likely that although the Sr sialon green phosphor represented by the formula (1) is to be prepared, the color of light emitted by excitation by ultraviolet light, violet light or blue light is not green; or it is likely that although the Sr sialon red phosphor represented by the formula (2) is to be prepared, the color of light emitted by excitation by ultraviolet light, violet light or blue light is not red.

When the baking temperature is more than 2000° C., due to an increased degree of elimination of N and O during baking, the obtained phosphor powder is likely to have a composition different from that of the Sr sialon green phosphor represented by the formula (1) or the Sr sialon red phosphor represented by the formula (2). Therefore, the phosphor powder is likely to have low emission intensity.

The baking time is generally 0.5 hour to 20 hours, preferably 1 hour to 10 hours, more preferably 1 hour to 5 hours, further preferably 1.5 hours to 2.5 hours.

When the baking time is less than 0.5 hour or more than 20 hours, the obtained phosphor powder is likely to have a composition different from that of the Sr sialon green phosphor represented by the formula (1) or the Sr sialon red phosphor represented by the formula (2). Therefore, the phosphor powder may have low emission intensity.

When the baking temperature is high, the baking time is preferably short, ranging from 0.5 hour to 20 hours. When the baking temperature is low, the baking time is preferably long, ranging from 0.5 hour to 20 hours.

A baked body of a phosphor powder is produced in the refractory crucible after baking. Generally, the baked body is a weakly solidified matter. The baked body is lightly cracked with a pestle or the like to give a phosphor powder. The phosphor powder prepared by cracking is powder of the Sr sialon green phosphor represented by the formula (1) or the Sr sialon red phosphor represented by the formula (2).

### [Light Emitting Device]

The light emitting device uses the Sr sialon green phosphor represented by the formula (1) or the Sr sialon red phosphor represented by the formula (2) described above.

More specifically, the light emitting device comprises a substrate, a semiconductor light emitting element which is arranged on the substrate and emits ultraviolet light, violet light or blue light, and a light emitting portion which is formed so as to cover a light emitting surface of the semiconductor light emitting element and contains a phosphor which emits visible light by being excited by light emitted from the semiconductor light emitting element, wherein the phosphor includes the Sr sialon green phosphor represented by the formula (1) or the Sr sialon red phosphor represented by the formula (2).

The light emitting device may contain, as a phosphor, either of the Sr sialon green phosphor represented by the formula (1) or the Sr sialon red phosphor represented by the formula (2), or both of the Sr sialon green phosphor represented by the formula (1) and the Sr sialon red phosphor represented by the formula (2).

In the light emitting device, when the phosphor present in the light emitting portion is only the Sr sialon green phosphor, the light emitting device emits green light from the emitting surface. When the phosphor present in the light emitting portion is only the Sr sialon red phosphor, the light emitting device emits red light from the emitting surface.

Alternatively, if it is designed so that the light emitting portion in the light emitting device contains a blue phosphor and a red phosphor such as the Sr sialon red phosphor in addition to the Sr sialon green phosphor, or a blue phosphor and a green phosphor such as the Sr sialon green phosphor in addition to the Sr sialon red phosphor, a white light emitting device which emits white light from the emitting surface due to the mixing of colors of light of red, blue and green emitted from the phosphors of the respective colors can be prepared.

Further, the light emitting device may contain another green phosphor in addition to the Sr sialon green phosphor or another red phosphor in addition to Sr sialon red phosphor.

The light emitting device may contain the Sr sialon green phosphor represented by the formula (1) and the Sr sialon red phosphor represented by the formula (2) as a phosphor. When both of the Sr sialon green phosphor and the Sr sialon red phosphor are present as a phosphor, the obtained light emitting device has good temperature properties.

### (Substrate)

Examples of a substrate used include ceramics such as alumina and aluminum nitride (AlN) and glass epoxy resin. A substrate of an alumina plate or an aluminum nitride plate is preferred because they have high thermal conductivity and can control temperature increase in LED light sources.

### (Semiconductor Light Emitting Element)

A semiconductor light emitting element is arranged on the substrate.

As the semiconductor light emitting element, a semiconductor light emitting element which emits ultraviolet light, violet light or blue light is used. Here, the ultraviolet light, violet light or blue light means light having a peak wavelength in the wavelength range of ultraviolet, violet or blue light. It is preferable that the ultraviolet light, violet light or blue light have a peak wavelength in the range of 370 nm or more and 470 nm or less.

Examples of the semiconductor light emitting element that emits ultraviolet light, violet light or blue light which are used include ultraviolet light-emitting diodes, violet light-emitting diodes, blue light-emitting diodes, ultraviolet laser diodes, violet laser diodes and blue laser diodes. When a laser diode is used as the semiconductor light emitting element, the peak wavelength described above means a peak oscillation wavelength.

### (Light Emitting Portion)

The light emitting portion contains, in a cured transparent resin, a phosphor which emits visible light by being excited by emitted light of ultraviolet light, violet light or blue light from the semiconductor light emitting element. The light emitting portion is formed so as to cover a light emitting surface of the semiconductor light emitting element.

The phosphor used in the light emitting portion includes at least the Sr sialon green phosphor or the Sr sialon red phosphor described above. Alternatively, the phosphor may include both of the Sr sialon green phosphor and the Sr sialon red phosphor.

Further, the phosphor used in the light emitting portion may include the Sr sialon green phosphor or the Sr sialon red phosphor described above, and a phosphor different from the Sr sialon green phosphor or the Sr sialon red phosphor. Examples of the phosphor different from the Sr sialon green phosphor or the Sr sialon red phosphor which may be used include a red phosphor, a blue phosphor, a green phosphor, a yellow phosphor, a violet phosphor and an orange phosphor. Phosphors in the form of powder are generally used.

In the light emitting portion, the phosphor is present in a cured transparent resin. Generally the phosphor is dispersed in the cured transparent resin.

The cured transparent resin used for the light emitting portion is a resin prepared by curing a transparent resin, that is, a resin having high transparency. Examples of transparent resins used include silicone resins and epoxy resins. Silicone resins are preferred because they have higher UV resistance than epoxy resins. Of silicone resins, dimethyl silicone resin is more preferred because of their high UV resistance.

It is preferred that the light emitting portion be composed of a cured transparent resin in a proportion of 20 to 1000 parts by mass based on 100 parts by mass of the phosphor. When the proportion of the cured transparent resin to the phosphor is in this range, the light emitting portion has high emission intensity.

The light emitting portion has a film thickness of generally 80 μm or more and 800 μm or less, and preferably 150 μm or more and 600 μm or less. When the light emitting portion has a film thickness of 80 μm or more and 800 μm or less, practical brightness can be secured with a small amount of leakage of ultraviolet light, violet light or blue light from the semiconductor light emitting element. When the light emitting portion has a film thickness of 150 μm or more and 600 μm or less, a brighter light can be emitted from the light emitting portion.

The light emitting portion is prepared by, for example, first mixing a transparent resin and a phosphor to prepare a phosphor slurry in which the phosphor is dispersed in the transparent resin, and then applying the phosphor slurry to a semiconductor light emitting element or to the inner surface of a globe, and curing.

When the phosphor slurry is applied to the semiconductor light emitting element, the light emitting portion covers the semiconductor light emitting element with being in contact therewith. When the phosphor slurry is applied to the inner surface of a globe, the light emitting portion is remote from the semiconductor light emitting element and formed on the inner surface of the globe. The light emitting device in which the light emitting portion is formed in the inner surface of the globe is called a remote phosphor LED light emitting device.

The phosphor slurry may be cured by heating at, for example, 100° C. to 160° C.

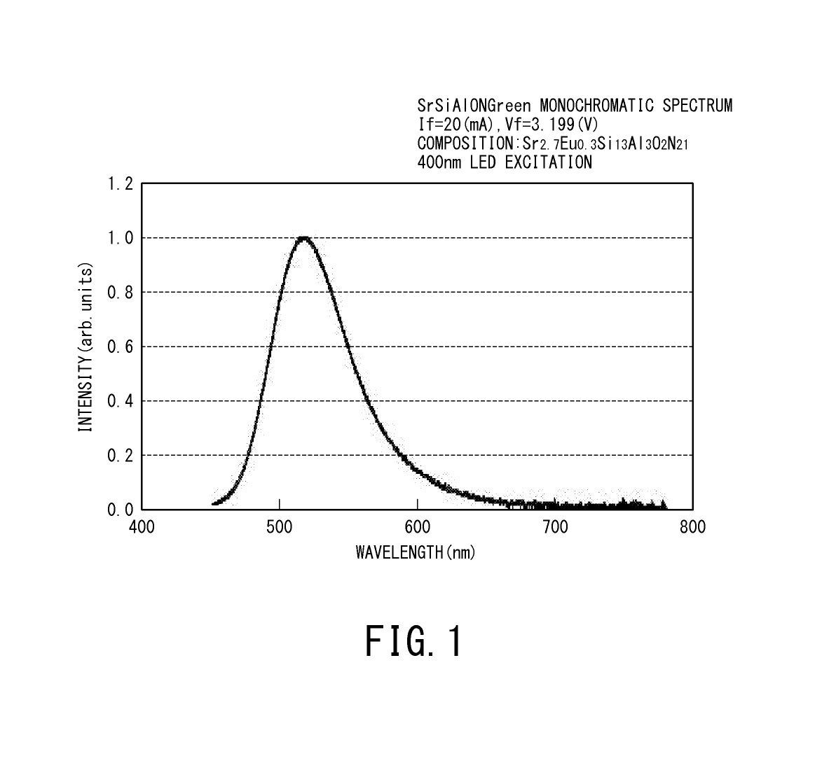

FIG. 1 illustrates an example of an emission spectrum of a light emitting device.

More specifically, FIG. 1 illustrates an emission spectrum of a green light emitting device at 25° C., in which a violet LED which emits violet light having a peak wavelength of 400 nm is used as a semiconductor light emitting element and only a Sr sialon green phosphor having a basic composition represented by Sr_{2.7}Eu_{0.3}Si₁₃Al₃O₂N₂₁ and containing 1% by mass of Y is used as a phosphor.

The violet LED has a forward voltage drop Vf of 3.199 V and a forward current If of 20 mA.

As shown in FIG. 1, the green light emitting device using the Sr sialon green phosphor represented by the formula (1) as a phosphor has high emission intensity even with a short-wavelength excitation light such as violet light.

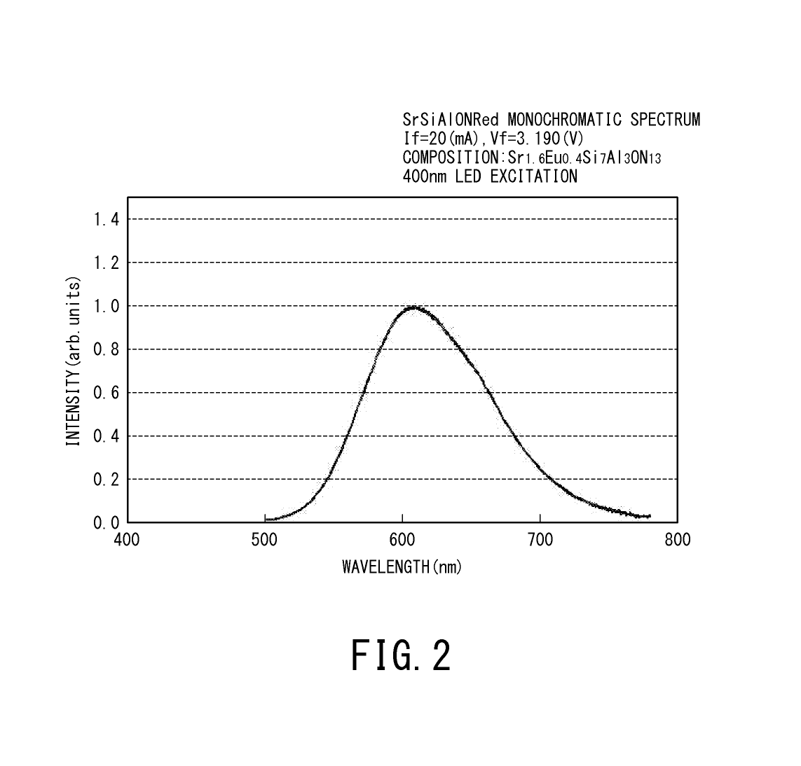

FIG. 2 illustrates another example of an emission spectrum of a light emitting device.

More specifically, FIG. 2 illustrates an emission spectrum of a red light emitting device at 25° C., in which a violet LED which emits violet light having a peak wavelength of 400 nm is used as a semiconductor light emitting element and only a Sr sialon red phosphor having a basic composition represented by Sr_{1.6}Eu_{0.4}Si₇Al₃ON₁₃ and containing 1% by mass of Y is used as a phosphor.

The violet LED has a forward voltage drop Vf of 3.190 V and a forward current If of 20 mA.

As shown in FIG. 2, the red light emitting device using the Sr sialon red phosphor represented by the formula (2) as a phosphor has high emission intensity even with a short-wavelength excitation light such as violet light.

### EXAMPLES

Examples will be shown below, but the present invention should not be construed as being limited thereto.

### (Preparation of Green Phosphor)

First, 337 g of SrCO₃, 104 g of AlN, 514 g of Si₃N₄, 44 g of Eu₂O₃ and 2 g of Sc₂O₃ as a non-Eu rare earth element were precisely weighed and an appropriate amount of a flux agent was added thereto, and the mixture was dry-mixed to prepare a mixture of phosphor raw materials (Sample No. 2). Thereafter, a boron nitride crucible was charged with the mixture of phosphor raw materials. Table 1 shows the amount of blending of the raw materials in the mixture of phosphor raw materials.

The boron nitride crucible charged with the mixture of phosphor raw materials was baked in an electric oven in a nitrogen atmosphere of 0.7 MPa (about 7 atm) at 1850° C. for 2 hours. As a result, a solidified baked powder was prepared in the crucible.

The solid was cracked and 10 times its mass of pure water was added to the baked powder, and the mixture was stirred for 10 minutes and filtered to prepare a baked powder. The procedure of washing the baked powder was repeated another 4 times to carry out washing for 5 times in total. The baked powder after washing was filtered and dried, and sieved through a nylon mesh with an aperture of 45 microns to prepare a baked powder (Sample No. 2).

The baked powder was analyzed and found to be a single crystal Sr sialon green phosphor having the composition shown in Table 2. The phosphor particles constituting the baked powder contained a non-Eu rare earth element of the type and amount shown in Table 2. Sample No. 2 contained non-Eu rare earth element Sc.

The content (% by mass) of the non-Eu rare earth element means the ratio of the mass of the non-Eu rare earth element to the mass of the entire baked powder including the non-Eu rare earth element. The non-Eu rare earth element was present in the particles constituting the phosphor powder (baked powder).

The basic composition of the baked powder and the result of measurement of the content of the non-Eu rare earth element in the baked powder are shown in Table 2.

The emission peak wavelength, the luminous efficiency and the average particle size of the obtained Sr sialon phosphor were measured.

The luminous efficiency was measured at room temperature (25° C.) and expressed as a relative value (%) with the luminous efficiency (lm/W) at room temperature in Comparative Example (Sample No. 1) described later as 100.

The average particle size is a measured value by a Coulter counter method, which is the median D₅₀ in volume cumulative distribution.

The results of the measurement of the emission peak wavelength, the emission intensity and the average particle size are shown in Table 3.

### (Preparation of Different Green Phosphors)

Green phosphors were prepared in the same manner as in Sample No. 2 except for changing the amount of blending of the raw materials in the mixture of phosphor raw materials as shown in Table 1 or Table 4 (Sample No. 1, Nos. 3 to 54, Nos. 61 to 75).

Sample No. 1 represents Comparative Example, which is essentially free of non-Eu rare earth elements. Sample Nos. 2 to 52 represent Examples in which the type and the content of the non-Eu rare earth element were changed. Sample Nos. 53 and 54 represent Examples in which the basic composition represented by the formula (1) was changed. Sample Nos. 61 to 75 represent Comparative Examples in which the content of the non-Eu rare earth element is extremely high.

The basic composition of the baked powder, the content of the non-Eu rare earth element in the baked powder, the emission peak wavelength, the emission intensity and the average particle size of the obtained green phosphors (Sample No. 1, Nos. 3 to 54, Nos. 61 to 75) were measured in the same manner as in Sample No. 2.

The basic composition of the baked powder and the content of the non-Eu rare earth element in the baked powder are shown in Table 2 and Table 5.

The results of the measurement of the emission peak wavelength, the emission intensity and the average particle size are shown in Table 3 and Table 6.

TABLE 1

| | | Type and Amount of Blending of Raw Material | | | | | | | |
|---|---|---|---|---|---|---|---|---|---|
| | | | | | | Oxide of Non-Eu | | Oxide of Non-Eu | |
| | | | | | | Rare Earth | | Rare Earth | |
| | | SrCO₃ | AlN | Si₃N₄ | Eu₂O₃ | Element | | Element | |
| | | Amount of | Amount of | Amount of | Amount of | | Amount of | | Amount of |
| | Sample | Blending | Blending | Blending | Blending | | Blending | | Blending |
| | No. | (g) | (g) | (g) | (g) | Type | (g) | Type | (g) |
| Compatative | 1 | 337 | 104 | 514 | 44 | — | — | — | — |
| Example | | | | | | | | | |
| Example | 2 | 337 | 104 | 514 | 44 | Sc₂O₃ | 2 | — | — |
| Example | 3 | 337 | 104 | 514 | 44 | Sc₂O₃ | 15 | — | — |
| Example | 4 | 337 | 104 | 514 | 44 | Sc₂O₃ | 153 | — | — |
| Example | 5 | 337 | 104 | 514 | 44 | Y₂O₃ | 1 | — | — |
| Example | 6 | 337 | 104 | 514 | 44 | Y₂O₃ | 13 | — | — |
| Example | 7 | 337 | 104 | 514 | 44 | Y₂O₃ | 127 | — | — |
| Example | 8 | 337 | 104 | 514 | 44 | La₂O₃ | 1 | — | |
| Example | 9 | 337 | 104 | 514 | 44 | La₂O₃ | 12 | — | |
| Example | 10 | 337 | 104 | 514 | 44 | La₂O₃ | 117 | — | — |
| Example | 11 | 337 | 104 | 514 | 44 | CeO₂ | 1 | — | |
| Example | 12 | 337 | 104 | 514 | 44 | CeO₂ | 12 | | — |
| Example | 13 | 337 | 104 | 514 | 44 | CeO₂ | 123 | — | — |
| Example | 14 | 337 | 104 | 514 | 44 | Pr₆O₁₁ | 1 | — | — |
| Example | 15 | 337 | 104 | 514 | 44 | Pr₆O₁₁ | 12 | — | — |
| Example | 16 | 337 | 104 | 514 | 44 | Pr₆O₁₁ | 121 | — | — |
| Example | 17 | 337 | 104 | 514 | 44 | Nd₂O₃ | 1 | — | — |
| Example | 18 | 337 | 104 | 514 | 44 | Nd₂O₃ | 12 | — | — |
| Example | 19 | 337 | 104 | 514 | 44 | Nd₂O₃ | 117 | — | — |
| Example | 20 | 337 | 104 | 514 | 44 | Sm₂O₃ | 1 | — | — |
| Example | 21 | 337 | 104 | 514 | 44 | Sm₂O₃ | 12 | — | — |
| Example | 22 | 337 | 104 | 514 | 44 | Sm₂O₃ | 116 | — | — |
| Example | 23 | 337 | 104 | 514 | 44 | Gd₂O₃ | 1 | — | — |
| Example | 24 | 337 | 104 | 514 | 44 | Gd₂O₃ | 12 | — | — |
| Example | 25 | 337 | 104 | 514 | 44 | Gd₂O₃ | 116 | — | — |
| Example | 26 | 337 | 104 | 514 | 44 | Tb₄O₇ | 1 | — | — |
| Example | 27 | 337 | 104 | 514 | 44 | Tb₄O₇ | 12 | — | — |
| Example | 28 | 337 | 104 | 514 | 44 | Tb₄O₇ | 118 | — | — |
| Example | 29 | 337 | 104 | 514 | 44 | Dy₂O₃ | 1 | — | — |
| Example | 30 | 337 | 104 | 514 | 44 | Dy₂O₃ | 11 | — | — |
| Example | 31 | 337 | 104 | 514 | 44 | Dy₂O₃ | 115 | | |
| Example | 32 | 337 | 104 | 514 | 44 | Ho₂O₃ | 1 | — | |
| Example | 33 | 337 | 104 | 514 | 44 | Ho₂O₃ | 11 | — | |
| Example | 34 | 337 | 104 | 514 | 44 | Ho₂O₃ | 115 | | — |

TABLE 2

| | | | Non-Eu Rare | | Non-Eu Rare | |
|---|---|---|---|---|---|---|
| | | | Earth Element | | Earth Element | |
| | | | contained in | | contained in | |
| | Sample | Basic Composition of Baked | Baked Powder | | Baked Powder | |
| | No. | Powder | Type | (mass %) | Type | (mass %) |
| Compatative | 1 | Sr_{2.7}Eu_{0.3}Si₁₃Al₃O₂N₂₁ | — | — | — | — |
| Example | | | | | | |
| Example | 2 | Sr_{2.7}Eu_{0.3}Si₁₃Al₃O₂N₂₁ | Sc | 0.1 | — | — |
| Example | 3 | Sr_{2.7}Eu_{0.3}Si₁₃Al₃O₂N₂₁ | Sc | 1 | — | — |
| Example | 4 | Sr_{2.7}Eu_{0.3}Si₁₃Al₃O₂N₂₁ | Sc | 10 | — | — |
| Example | 5 | Sr_{2.7}Eu_{0.3}Si₁₃Al₃O₂N₂₁ | Y | 0.1 | — | — |
| Example | 6 | Sr_{2.7}Eu_{0.3}Si₁₃Al₃O₂N₂₁ | Y | 1 | — | — |
| Example | 7 | Sr_{2.7}Eu_{0.3}Si₁₃Al₃O₂N₂₁ | Y | 10 | — | — |
| Example | 8 | Sr_{2.7}Eu_{0.3}Si₁₃Al₃O₂N₂₁ | La | 0.1 | — | — |
| Example | 9 | Sr_{2.7}Eu_{0.3}Si₁₃Al₃O₂N₂₁ | La | 1 | — | — |
| Example | 10 | Sr_{2.7}Eu_{0.3}Si₁₃Al₃O₂N₂₁ | La | 10 | — | — |
| Example | 11 | Sr_{2.7}Eu_{0.3}Si₁₃Al₃O₂N₂₁ | Ce | 0.1 | — | — |
| Example | 12 | Sr_{2.7}Eu_{0.3}Si₁₃Al₃O₂N₂₁ | Ce | 1 | — | — |
| Example | 13 | Sr_{2.7}Eu_{0.3}Si₁₃Al₃O₂N₂₁ | Ce | 10 | — | — |
| Example | 14 | Sr_{2.7}Eu_{0.3}Si₁₃Al₃O₂N₂₁ | Pr | 0.1 | — | — |
| Example | 15 | Sr_{2.7}Eu_{0.3}Si₁₃Al₃O₂N₂₁ | Pr | 1 | — | — |
| Example | 16 | Sr_{2.7}Eu_{0.3}Si₁₃Al₃O₂N₂₁ | Pr | 10 | — | — |
| Example | 17 | Sr_{2.7}Eu_{0.3}Si₁₃Al₃O₂N₂₁ | Nd | 0.1 | — | — |
| Example | 18 | Sr_{2.7}Eu_{0.3}Si₁₃Al₃O₂N₂₁ | Nd | 1 | — | — |
| Example | 19 | Sr_{2.7}Eu_{0.3}Si₁₃Al₃O₂N₂₁ | Nd | 10 | — | — |
| Example | 20 | Sr_{2.7}Eu_{0.3}Si₁₃Al₃O₂N₂₁ | Sm | 0.1 | — | — |
| Example | 21 | Sr_{2.7}Eu_{0.3}Si₁₃Al₃O₂N₂₁ | Sm | 1 | — | — |
| Example | 22 | Sr_{2.7}Eu_{0.3}Si₁₃Al₃O₂N₂₁ | Sm | 10 | — | — |
| Example | 23 | Sr_{2.7}Eu_{0.3}Si₁₃Al₃O₂N₂₁ | Gd | 0.1 | — | — |
| Example | 24 | Sr_{2.7}Eu_{0.3}Si₁₃Al₃O₂N₂₁ | Gd | 1 | — | — |
| Example | 25 | Sr_{2.7}Eu_{0.3}Si₁₃Al₃O₂N₂₁ | Gd | 10 | — | — |
| Example | 26 | Sr_{2.7}Eu_{0.3}Si₁₃Al₃O₂N₂₁ | Tb | 0.1 | — | — |
| Example | 27 | Sr_{2.7}Eu_{0.3}Si₁₃Al₃O₂N₂₁ | Tb | 1 | — | — |
| Example | 28 | Sr_{2.7}Eu_{0.3}Si₁₃Al₃O₂N₂₁ | Tb | 10 | — | — |
| Example | 29 | Sr_{2.7}Eu_{0.3}Si₁₃Al₃O₂N₂₁ | Dy | 0.1 | — | — |
| Example | 30 | Sr_{2.7}Eu_{0.3}Si₁₃Al₃O₂N₂₁ | Dy | 1 | — | — |
| Example | 31 | Sr_{2.7}Eu_{0.3}Si₁₃Al₃O₂N₂₁ | Dy | 10 | — | — |
| Example | 32 | Sr_{2.7}Eu_{0.3}Si₁₃Al₃O₂N₂₁ | Ho | 0.1 | — | — |
| Example | 33 | Sr_{2.7}Eu_{0.3}Si₁₃Al₃O₂N₂₁ | Ho | 1 | — | — |
| Example | 34 | Sr_{2.7}Eu_{0.3}Si₁₃Al₃O₂N₂₁ | Ho | 10 | — | — |

TABLE 3

| | | Emission | | Average | |
|---|---|---|---|---|---|
| | | Peak | Luminous | Particle | |
| | Sample | Wavelength | Efficiency | Size D₅₀ | |
| | No. | (nm) | (%) | (μm) | Remarks |
| Compatative | 1 | 520 | 100 | 10 | Non-Eu rare earth element was not added. |
| Example | | | | | |
| Example | 2 | 521 | 100 | 12 | Crystal grain growth was promoted. Luminous efficiency was as normal. |
| Example | 3 | 521 | 105 | 15 | Crystal grain growth was promoted. Luminous efficiency was increased. |
| Example | 4 | 520 | 104 | 16 | Crystal grain growth was promoted. Luminous efficiency was increased. |
| Example | 5 | 520 | 105 | 20 | Crystal grain growth was promoted strongly. Luminous efficiency was |
| | | | | | increased. |
| Example | 6 | 520 | 110 | 30 | Crystal grain growth was promoted strongly. Luminous efficiency was |
| | | | | | increased. |
| Example | 7 | 520 | 120 | 80 | Crystal grain growth was promoted strongly. Luminous efficiency was |
| | | | | | increased. |
| Example | 8 | 520 | 102 | 10 | Luminous efficiency was increased by improving crystalline properties. |
| Example | 9 | 520 | 102 | 13 | Luminous efficiency was increased by improving crystalline properties. |
| Example | 10 | 520 | 102 | 13 | Luminous efficiency was increased by improving crystalline properties. |
| Example | 11 | 520 | 103 | 14 | Luminous efficiency was increased by improving crystalline properties. |
| Example | 12 | 520 | 104 | 14 | Luminous efficiency was increased by improving crystalline properties. |
| Example | 13 | 520 | 103 | 14 | Luminous efficiency was increased by improving crystalline properties. |
| Example | 14 | 520 | 101 | 9 | Luminous efficiency was increased by improving crystalline properties. |
| Example | 15 | 520 | 102 | 9 | Luminous efficiency was increased by improving crystalline properties. |
| Example | 16 | 520 | 103 | 8 | Luminous efficiency was increased by improving crystalline properties. |
| Example | 17 | 521 | 100 | 15 | Crystal grain growth was promoted. Luminous efficiency was as normal. |
| Example | 18 | 521 | 102 | 18 | Crystal grain growth was promoted. Luminous efficiency was increased. |
| Example | 19 | 521 | 104 | 23 | Crystal grain growth was promoted. Luminous efficiency was increased. |
| Example | 20 | 520 | 101 | 12 | Luminous efficiency was increased by improving crystalline properties. |
| Example | 21 | 520 | 102 | 11 | Luminous efficiency was increased by improving crystalline properties. |
| Example | 22 | 520 | 103 | 13 | Luminous efficiency was increased by improving crystalline properties. |
| Example | 23 | 520 | 104 | 13 | Luminous efficiency was increased by improving crystalline properties. |
| Example | 24 | 520 | 104 | 13 | Luminous efficiency was increased by improving crystalline properties. |
| Example | 25 | 520 | 102 | 13 | Luminous efficiency was increased by improving crystalline properties. |
| Example | 26 | 520 | 103 | 10 | Luminous efficiency was increased by improving crystalline properties. |
| Example | 27 | 520 | 103 | 11 | Luminous efficiency was increased by improving crystalline properties. |
| Example | 28 | 520 | 103 | 11 | Luminous efficiency was increased by improving crystalline properties. |
| Example | 29 | 520 | 103 | 9 | Luminous efficiency was increased by improving crystalline properties. |
| Example | 30 | 520 | 103 | 11 | Luminous efficiency was increased by improving crystalline properties. |
| Example | 31 | 520 | 102 | 9 | Luminous efficiency was increased by improving crystalline properties. |
| Example | 32 | 520 | 105 | 13 | Luminous efficiency was increased by improving crystalline properties. |
| Example | 33 | 520 | 103 | 12 | Luminous efficiency was increased by improving crystalline properties. |
| Example | 34 | 520 | 105 | 11 | Luminous efficiency was increased by improving crystalline properties. |

TABLE 4

| | | Type and Amount of Blending of Raw Material | | | | | | | |
|---|---|---|---|---|---|---|---|---|---|
| | | | | | | Oxide of Non-Eu | | Oxide of Non-Eu | |
| | | | | | | Rare Earth | | Rare Earth | |
| | | SrCO₃ | AlN | Si₃N₄ | Eu₂O₃ | Element | | Element | |
| | | Amount of | Amount of | Amount of | Amount of | | Amount of | | Amount of |
| | Sample | Blending | Blending | Blending | Blending | | Blending | | Blending |
| | No. | (g) | (g) | (g) | (g) | Type | (g) | Type | (g) |
| Example | 35 | 337 | 104 | 514 | 44 | Er₂O₃ | 1 | — | — |
| Example | 36 | 337 | 104 | 514 | 44 | Er₂O₃ | 11 | — | — |
| Example | 37 | 337 | 104 | 514 | 44 | Er₂O₃ | 114 | — | — |
| Example | 38 | 337 | 104 | 514 | 44 | Tm₂O₃ | 1 | — | — |
| Example | 39 | 337 | 104 | 514 | 44 | Tm₂O₃ | 11 | — | — |
| Example | 40 | 337 | 104 | 514 | 44 | Tra₂O₃ | 114 | — | — |
| Example | 41 | 337 | 104 | 514 | 44 | Yb₂O₃ | 1 | — | — |
| Example | 42 | 337 | 104 | 514 | 44 | Yb₂O₃ | 11 | — | — |
| Example | 43 | 337 | 104 | 514 | 44 | Yb₂O₃ | 114 | — | — |
| Example | 44 | 337 | 104 | 514 | 44 | Lu₂O₃ | 1 | — | — |
| Example | 45 | 337 | 104 | 514 | 44 | Lu₂O₃ | 11 | — | — |
| Example | 46 | 337 | 104 | 514 | 44 | Lu₂O₃ | 114 | — | — |
| Example | 47 | 337 | 104 | 514 | 44 | Y₂O₃ | 13 | La₂O₃ | 12 |
| Example | 48 | 337 | 104 | 514 | 44 | Y₂O₃ | 13 | CeO₂ | 12 |
| Example | 49 | 337 | 104 | 514 | 44 | Y₂O₃ | 13 | Pr₆O₁₁ | 12 |
| Example | 50 | 337 | 104 | 514 | 44 | Y₂O₃ | 13 | Nd₂O₃ | 12 |
| Example | 51 | 337 | 104 | 514 | 44 | Y₂O₃ | 13 | Gd₂O₃ | 12 |
| Example | 52 | 337 | 104 | 514 | 44 | Y₂O₃ | 13 | Lu₂O₃ | 11 |
| Example | 53 | 316 | 146 | 500 | 38 | Y₂O₃ | 13 | — | — |
| Example | 54 | 332 | 110 | 501 | 57 | Y₂O₃ | 13 | — | — |
| Compatative | 61 | 337 | 104 | 514 | 44 | Sc₂O₃ | 230 | — | — |
| Example | | | | | | | | | |
| Compatative | 62 | 337 | 104 | 514 | 44 | Y₂O₃ | 190 | — | — |
| Example | | | | | | | | | |
| Compatative | 63 | 337 | 104 | 514 | 44 | La₂O₃ | 176 | — | — |
| Example | | | | | | | | | |
| Compatative | 64 | 337 | 104 | 514 | 44 | CeO₂ | 184 | — | — |
| Example | | | | | | | | | |
| Compatative | 65 | 337 | 104 | 514 | 44 | Pr₆O₁₁ | 181 | — | — |
| Example | | | | | | | | | |
| Compatative | 66 | 337 | 104 | 514 | 44 | Nd₂O₃ | 175 | — | — |
| Example | | | | | | | | | |
| Compatative | 67 | 337 | 104 | 514 | 44 | Sm₂O₃ | 174 | — | — |
| Example | | | | | | | | | |
| Compatative | 68 | 337 | 104 | 514 | 44 | Gd₂O₃ | 173 | — | — |
| Example | | | | | | | | | |
| Compatative | 69 | 337 | 104 | 514 | 44 | Tb₄O₇ | 176 | — | — |
| Example | | | | | | | | | |
| Compatative | 70 | 337 | 104 | 514 | 44 | Dy₂O₃ | 172 | — | — |
| Example | | | | | | | | | |
| Compatative | 71 | 337 | 104 | 514 | 44 | Ho₂O₃ | 172 | — | — |
| Example | | | | | | | | | |
| Compatative | 72 | 337 | 104 | 514 | 44 | Er₂O₃ | 172 | — | — |
| Example | | | | | | | | | |
| Compatative | 73 | 337 | 104 | 514 | 44 | Tm₂O₃ | 171 | — | — |
| Example | | | | | | | | | |
| Compatative | 74 | 337 | 104 | 514 | 44 | Yb₂O₃ | 171 | — | — |
| Example | | | | | | | | | |
| Compatative | 75 | 337 | 104 | 514 | 44 | Lu₂O₃ | 171 | — | — |
| Example | | | | | | | | | |

TABLE 5

| | | | Non-Eu Rare | | Non-Eu Rare | |
|---|---|---|---|---|---|---|
| | | | Earth Element | | Earth Element | |
| | | | contained in | | contained in | |
| | Sample | Basic Composition of Baked | Baked Powder | | Baked Powder | |
| | No. | Powder | Type | (mass %) | Type | (mass %) |
| Example | 35 | Sr_{2.7}Eu_{0.3}Si₁₃Al₃O₂N₂₁ | Er | 0.1 | — | — |
| Example | 36 | Sr_{2.7}Eu_{0.3}Si₁₃Al₃O₂N₂₁ | Er | 1 | — | — |
| Example | 37 | Sr_{2.7}Eu_{0.3}Si₁₃Al₃O₂N₂₁ | Er | 10 | — | — |
| Example | 38 | Sr_{2.7}Eu_{0.3}Si₁₃Al₃O₂N₂₁ | Tm | 0.1 | — | — |
| Example | 39 | Sr_{2.7}Eu_{0.3}Si₁₃Al₃O₂N₂₁ | Tm | 1 | — | — |
| Example | 40 | Sr_{2.7}Eu_{0.3}Si₁₃Al₃O₂N₂₁ | Tm | 10 | — | — |
| Example | 41 | Sr_{2.7}Eu_{0.3}Si₁₃Al₃O₂N₂₁ | Yb | 0.1 | — | — |
| Example | 42 | Sr_{2.7}Eu_{0.3}Si₁₃Al₃O₂N₂₁ | Yb | 1 | — | — |
| Example | 43 | Sr_{2.7}Eu_{0.3}Si₁₃Al₃O₂N₂₁ | Yb | 10 | — | — |
| Example | 44 | Sr_{2.7}Eu_{0.3}Si₁₃Al₃O₂N₂₁ | Lu | 0.1 | — | — |
| Example | 45 | Sr_{2.7}Eu_{0.3}Si₁₃Al₃O₂N₂₁ | Lu | 1 | — | — |
| Example | 46 | Sr_{2.7}Eu_{0.3}Si₁₃Al₃O₂N₂₁ | Lu | 10 | — | — |
| Example | 47 | Sr_{2.7}Eu_{0.3}Si₁₃Al₃O₂N₂₁ | Y | 1 | La | 1 |
| Example | 48 | Sr_{2.7}Eu_{0.3}Si₁₃Al₃O₂N₂₁ | Y | 1 | Ce | 1 |
| Example | 49 | Sr_{2.7}Eu_{0.3}Si₁₃Al₃O₂N₂₁ | Y | 1 | Pr | 1 |
| Example | 50 | Sr_{2.7}Eu_{0.3}Si₁₃Al₃O₂N₂₁ | Y | 1 | Nd | 1 |
| Example | 51 | Sr_{2.7}Eu_{0.3}Si₁₃Al₃O₂N₂₁ | Y | 1 | Gd | 1 |
| Example | 52 | Sr_{2.7}Eu_{0.3}Si₁₃Al₃O₂N₂₁ | Y | 1 | Lu | 1 |
| Example | 53 | Sr_{3.0}Eu_{0.3}Si₁₅Al₅O₂N₂₁ | Y | 1 | — | — |
| Example | 54 | Sr_{2.1}Eu_{0.3}Si₁₀Al_{2.5}O₂N₂₁ | Y | 1 | — | — |
| Compatative | 61 | Sr_{2.7}Eu_{0.3}Si₁₃Al₃O₂N₂₁ | Sc | 15 | — | — |
| Example | | | | | | |
| Compatative | 62 | Sr_{2.7}Eu_{0.3}Si₁₃Al₃O₂N₂₁ | Y | 15 | — | — |
| Example | | | | | | |
| Compatative | 63 | Sr_{2.7}Eu_{0.3}Si₁₃Al₃O₂N₂₁ | La | 15 | — | — |
| Example | | | | | | |
| Compatative | 64 | Sr_{2.7}Eu_{0.3}Si₁₃Al₃O₂N₂₁ | Ce | 15 | — | — |
| Example | | | | | | |
| Compatative | 65 | Sr_{2.7}Eu_{0.3}Si₁₃Al₃O₂N₂₁ | Pr | 15 | — | — |
| Example | | | | | | |
| Compatative | 66 | Sr_{2.7}Eu_{0.3}Si₁₃Al₃O₂N₂₁ | Nd | 15 | — | — |
| Example | | | | | | |
| Compatative | 67 | Sr_{2.7}Eu_{0.3}Si₁₃Al₃O₂N₂₁ | Sm | 15 | — | — |
| Example | | | | | | |
| Compatative | 68 | Sr_{2.7}Eu_{0.3}Si₁₃Al₃O₂N₂₁ | Gd | 15 | — | — |
| Example | | | | | | |
| Compatative | 69 | Sr_{2.7}Eu_{0.3}Si₁₃Al₃O₂N₂₁ | Tb | 15 | — | — |
| Example | | | | | | |
| Compatative | 70 | Sr_{2.7}Eu_{0.3}Si₁₃Al₃O₂N₂₁ | Dy | 15 | — | — |
| Example | | | | | | |
| Compatative | 71 | Sr_{2.7}Eu_{0.3}Si₁₃Al₃O₂N₂₁ | Ho | 15 | — | — |
| Example | | | | | | |
| Compatative | 72 | Sr_{2.7}Eu_{0.3}Si₁₃Al₃O₂N₂₁ | Er | 15 | — | — |
| Example | | | | | | |
| Compatative | 73 | Sr_{2.7}Eu_{0.3}Si₁₃Al₃O₂N₂₁ | Tm | 15 | — | — |
| Example | | | | | | |
| Compatative | 74 | Sr_{2.7}Eu_{0.3}Si₁₃Al₃O₂N₂₁ | Yb | 15 | — | — |
| Example | | | | | | |
| Compatative | 75 | Sr_{2.7}Eu_{0.3}Si₁₃Al₃O₂N₂₁ | Lu | 15 | — | — |
| Example | | | | | | |

TABLE 6

| | | Emission | | Average | |
|---|---|---|---|---|---|
| | | Peak | Luminous | Particle | |
| | Sample | Wavelength | Efficiency | Size D₅₀ | |
| | No. | (nm) | (%) | (μm) | Remarks |
| Example | 35 | 520 | 103 | 10 | Luminous efficiency was increased by improving crystalline properties. |
| Example | 36 | 520 | 103 | 10 | Luminous efficiency was increased by improving crystalline properties. |
| Example | 37 | 520 | 103 | 10 | Luminous efficiency was increased by improving crystalline properties. |
| Example | 38 | 520 | 104 | 13 | Luminous efficiency was increased by improving crystalline properties. |
| Example | 39 | 520 | 103 | 12 | Luminous efficiency was increased by improving crystalline properties. |
| Example | 40 | 520 | 104 | 11 | Luminous efficiency was increased by improving crystalline properties. |
| Example | 41 | 520 | 103 | 13 | Luminous efficiency was increased by improving crystalline properties. |
| Example | 42 | 520 | 106 | 15 | Luminous efficiency was increased by improving crystalline properties. |
| Example | 43 | 520 | 106 | 15 | Luminous efficiency was increased by improving crystalline properties. |
| Example | 44 | 520 | 102 | 16 | Crystal grain growth was promoted. Luminous efficiency was increased. |
| Example | 45 | 520 | 105 | 25 | Crystal grain growth was promoted. Luminous efficiency was increased. |
| Example | 46 | 520 | 109 | 30 | Crystal grain growth was promoted. Luminous efficiency was increased. |
| Example | 47 | 520 | 110 | 35 | Crystal grain growth was promoted strongly. Luminous efficiency was increased. |
| Example | 48 | 520 | 112 | 25 | Crystal grain growth was promoted strongly. Luminous efficiency was increased. |
| Example | 49 | 520 | 115 | 25 | Crystal grain growth was promoted strongly. Luminous efficiency was increased. |
| Example | 50 | 520 | 110 | 30 | Crystal grain growth was promoted strongly. Luminous efficiency was increased. |
| Example | 51 | 520 | 110 | 33 | Crystal grain growth was promoted strongly. Luminous efficiency was increased. |
| Example | 52 | 520 | 118 | 40 | Crystal grain growth was promoted strongly. Luminous efficiency was increased. |
| Example | 53 | 520 | 111 | 25 | Crystal grain growth was promoted strongly. Luminous efficiency was increased. |
| Example | 54 | 520 | 110 | 30 | Crystal grain growth was promoted strongly. Luminous efficiency was increased. |
| Compatative | 61 | 520 | 90 | 10 | Luminous efficiency was decreased by containing impurrties. |
| Example | | | | | |
| Compatative | 62 | 520 | 95 | 150 | Crystal grain was grown excessively. |
| Example | | | | | Coating the resin containing paprticle to LED was difficult. |
| Compatative | 63 | 520 | 90 | 12 | Luminous efficiency was decreased by containing impurrties. |
| Example | | | | | |
| Compatative | 64 | 520 | 82 | 12 | Luminous efficiency was decreased by containing impurrties. |
| Example | | | | | |
| Compatative | 65 | 520 | 81 | 13 | Luminous efficiency was decreased by containing impurrties. |
| Example | | | | | |
| Compatative | 66 | 520 | 80 | 11 | Luminous efficiency was decreased by containing impurrties. |
| Example | | | | | |
| Compatative | 67 | 520 | 75 | 14 | Luminous efficiency was decreased by containing impurrties. |
| Example | | | | | |
| Compatative | 68 | 520 | 80 | 10 | Luminous efficiency was decreased by containing impurrties. |
| Example | | | | | |
| Compatative | 69 | 520 | 85 | 13 | Luminous efficiency was decreased by containing impurrties. |
| Example | | | | | |
| Compatative | 70 | 520 | 86 | 13 | Luminous efficiency was decreased by containing impurrties. |
| Example | | | | | |
| Compatative | 71 | 520 | 89 | 14 | Luminous efficiency was decreased by containing impurrties. |
| Example | | | | | |
| Compatative | 72 | 520 | 70 | 14 | Luminous efficiency was decreased by containing impurrties. |
| Example | | | | | |
| Compatative | 73 | 520 | 72 | 12 | Luminous efficiency was decreased by containing impurrties. |
| Example | | | | | |
| Compatative | 74 | 520 | 90 | 16 | Luminous efficiency was decreased by containing impurrties. |
| Example | | | | | |
| Compatative | 75 | 520 | 91 | 18 | Luminous efficiency was decreased by containing impurrties. |
| Example | | | | | |

### (Preparation of Red Phosphor)

Baked powders were prepared in the same manner as in Sample No. 2 except for changing the amount of blending of the raw materials in the mixture of phosphor raw materials as shown in Table 7 or Table 10 (Sample Nos. 101 to 154, Nos. 161 to 175).

The baked powders were analyzed and found to be a single crystal Sr sialon red phosphor having the composition shown in Table 8 or Table 11. Further, the phosphor particles constituting the baked powder contained a non-Eu rare earth element of the type and amount shown in Table 8 or Table 11. The non-Eu rare earth element was present in the particles constituting the phosphor powder (baked powder).

Sample No. 101 represents Comparative Example, which is essentially free of non-Eu rare earth elements. Sample Nos. 102 to 152 represent Examples in which the type and the content of the non-Eu rare earth element were changed. Sample Nos. 153 and 154 represent Examples in which the basic composition represented by the formula (2) was changed. Sample Nos. 161 to 175 represent Comparative Examples in which the content of the non-Eu rare earth element is extremely high.

The basic composition of the baked powder, the content of the non-Eu rare earth element in the baked powder, the emission peak wavelength, the emission intensity and the average particle size of the obtained red phosphors (Sample Nos. 101 to 154, Nos. 161 to 175) were measured in the same manner as in Sample No. 2 of the green phosphor.

The basic composition of the baked powder and the content of the non-Eu rare earth element in the baked powder are shown in Table 8 and Table 11.

The results of the measurement of the emission peak wavelength, the emission intensity and the average particle size are shown in Table 9 and Table 12.

TABLE 7

| | | Type and Amount of Blending of Raw Material | | | | | | | |
|---|---|---|---|---|---|---|---|---|---|
| | | | | | | Oxide of Non-Eu | | Oxide of Non-Eu | |
| | | | | | | Rare Earth | | Rare Earth | |
| | | SrCO₃ | AlN | Si₃N₄ | Eu₂O₃ | Element | | Element | |
| | | Amount of | Amount of | Amount of | Amount of | | Amount of | | Amount of |
| | Sample | Blending | Blending | Blending | Blending | | Blending | | Blending |
| | No. | (g) | (g) | (g) | (g) | Type | (g) | Type | (g) |
| Compatative | 101 | 312 | 162 | 432 | 93 | — | — | — | — |
| Example | | | | | | | | | |
| Example | 102 | 312 | 162 | 432 | 93 | Sc₂O₃ | 2 | — | — |
| Example | 103 | 312 | 162 | 432 | 93 | Sc₂O₃ | 15 | — | — |
| Example | 104 | 312 | 162 | 432 | 93 | Sc₂O₃ | 153 | — | — |
| Example | 105 | 312 | 162 | 432 | 93 | Y₂O₃ | 1 | — | — |
| Example | 106 | 312 | 162 | 432 | 93 | Y₂O₃ | 13 | — | — |
| Example | 107 | 312 | 162 | 432 | 93 | Y₂O₃ | 127 | — | — |
| Example | 108 | 312 | 162 | 432 | 93 | La₂O₃ | 1 | — | — |
| Example | 109 | 312 | 162 | 432 | 93 | La₂O₃ | 12 | — | — |
| Example | 110 | 312 | 162 | 432 | 93 | La₂O₃ | 117 | — | — |
| Example | 111 | 312 | 162 | 432 | 93 | CeO₂ | 1 | — | — |
| Example | 112 | 312 | 162 | 432 | 93 | CeO₂ | 12 | — | — |
| Example | 113 | 312 | 162 | 432 | 93 | CeO₂ | 123 | — | — |
| Example | 114 | 312 | 162 | 432 | 93 | Pr₆O₁₁ | 1 | — | — |
| Example | 115 | 312 | 162 | 432 | 93 | Pr₆O₁₁ | 12 | — | — |
| Example | 116 | 312 | 162 | 432 | 93 | Pr₆O₁₁ | 121 | — | — |
| Example | 117 | 312 | 162 | 432 | 93 | Nd₂O₃ | 1 | — | — |
| Example | 118 | 312 | 162 | 432 | 93 | Nd₂O₃ | 12 | — | — |
| Example | 119 | 312 | 162 | 432 | 93 | Nd₂O₃ | 117 | — | — |
| Example | 120 | 312 | 162 | 432 | 93 | Sm₂O₃ | 1 | — | — |
| Example | 121 | 312 | 162 | 432 | 93 | Sm₂O₃ | 12 | — | — |
| Example | 122 | 312 | 162 | 432 | 93 | Sm₂O₃ | 116 | — | — |
| Example | 123 | 312 | 162 | 432 | 93 | Gd₂O₃ | 1 | — | — |
| Example | 124 | 312 | 162 | 432 | 93 | Gd₂O₃ | 12 | — | — |
| Example | 125 | 312 | 162 | 432 | 93 | Gd₂O₃ | 116 | — | — |
| Example | 126 | 312 | 162 | 432 | 93 | Tb₄O₇ | 1 | — | — |
| Example | 127 | 312 | 162 | 432 | 93 | Tb₄O₇ | 12 | — | — |
| Example | 128 | 312 | 162 | 432 | 93 | Tb₄O₇ | 118 | — | — |
| Example | 129 | 312 | 162 | 432 | 93 | Dy₂O₃ | 1 | — | — |
| Example | 130 | 312 | 162 | 432 | 93 | Dy₂O₃ | 11 | — | — |
| Example | 131 | 312 | 162 | 432 | 93 | Dy₂O₃ | 115 | — | — |
| Example | 132 | 312 | 162 | 432 | 93 | Ho₂O₃ | 1 | — | — |
| Example | 133 | 312 | 162 | 432 | 93 | Ho₂O₃ | 11 | — | — |
| Example | 134 | 312 | 162 | 432 | 93 | Ho₂O₃ | 115 | — | — |

TABLE 8

| | | | Non-Eu Rare | | Non-Eu Rare | |
|---|---|---|---|---|---|---|
| | | | Earth Element | | Earth Element | |
| | | | contained in | | contained in | |
| | Sample | Basic Composition of Baked | Baked Powder | | Baked Powder | |
| | No. | Powder | Type | (mass %) | Type | (mass %) |
| Compatative | 101 | Sr_{1.6}Eu_{0.4}Si₇Al₃ON₁₃ | — | — | — | — |
| Example | | | | | | |
| Example | 102 | Sr_{1.6}Eu_{0.4}Si₇Al₃ON₁₃ | Sc | 0.1 | — | — |
| Example | 103 | Sr_{1.6}Eu_{0.4}Si₇Al₃ON₁₃ | Sc | 1 | — | — |
| Example | 104 | Sr_{1.6}Eu_{0.4}Si₇Al₃ON₁₃ | Sc | 10 | — | — |
| Example | 105 | Sr_{1.6}Eu_{0.4}Si₇Al₃ON₁₃ | Y | 0.1 | — | — |
| Example | 106 | Sr_{1.6}Eu_{0.4}Si₇Al₃ON₁₃ | Y | 1 | — | — |
| Example | 107 | Sr_{1.6}Eu_{0.4}Si₇Al₃ON₁₃ | Y | 10 | — | — |
| Example | 108 | Sr_{1.6}Eu_{0.4}Si₇Al₃ON₁₃ | La | 0.1 | — | — |
| Example | 109 | Sr_{1.6}Eu_{0.4}Si₇Al₃ON₁₃ | La | 1 | — | — |
| Example | 110 | Sr_{1.6}Eu_{0.4}Si₇Al₃ON₁₃ | La | 10 | — | — |
| Example | 111 | Sr_{1.6}Eu_{0.4}Si₇Al₃ON₁₃ | Ce | 0.1 | — | — |
| Example | 112 | Sr_{1.6}Eu_{0.4}Si₇Al₃ON₁₃ | Ce | 1 | — | — |
| Example | 113 | Sr_{1.6}Eu_{0.4}Si₇Al₃ON₁₃ | Ce | 10 | — | — |
| Example | 114 | Sr_{1.6}Eu_{0.4}Si₇Al₃ON₁₃ | Pr | 0.1 | — | — |
| Example | 115 | Sr_{1.6}Eu_{0.4}Si₇Al₃ON₁₃ | Pr | 1 | — | — |
| Example | 116 | Sr_{1.6}Eu_{0.4}Si₇Al₃ON₁₃ | Pr | 10 | — | — |
| Example | 117 | Sr_{1.6}Eu_{0.4}Si₇Al₃ON₁₃ | Nd | 0.1 | — | — |
| Example | 118 | Sr_{1.6}Eu_{0.4}Si₇Al₃ON₁₃ | Nd | 1 | — | — |
| Example | 119 | Sr_{1.6}Eu_{0.4}Si₇Al₃ON₁₃ | Nd | 10 | — | — |
| Example | 120 | Sr_{1.6}Eu_{0.4}Si₇Al₃ON₁₃ | Sm | 0.1 | — | — |
| Example | 121 | Sr_{1.6}Eu_{0.4}Si₇Al₃ON₁₃ | Sm | 1 | — | — |
| Example | 122 | Sr_{1.6}Eu_{0.4}Si₇Al₃ON₁₃ | Sm | 10 | — | — |
| Example | 123 | Sr_{1.6}Eu_{0.4}Si₇Al₃ON₁₃ | Gd | 0.1 | — | — |
| Example | 124 | Sr_{1.6}Eu_{0.4}Si₇Al₃ON₁₃ | Gd | 1 | — | — |
| Example | 125 | Sr_{1.6}Eu_{0.4}Si₇Al₃ON₁₃ | Gd | 10 | — | — |
| Example | 126 | Sr_{1.6}Eu_{0.4}Si₇Al₃ON₁₃ | Tb | 0.1 | — | — |
| Example | 127 | Sr_{1.6}Eu_{0.4}Si₇Al₃ON₁₃ | Tb | 1 | — | — |
| Example | 128 | Sr_{1.6}Eu_{0.4}Si₇Al₃ON₁₃ | Tb | 10 | — | — |
| Example | 129 | Sr_{1.6}Eu_{0.4}Si₇Al₃ON₁₃ | Dy | 0.1 | — | — |
| Example | 130 | Sr_{1.6}Eu_{0.4}Si₇Al₃ON₁₃ | Dy | 1 | — | — |
| Example | 131 | Sr_{1.6}Eu_{0.4}Si₇Al₃ON₁₃ | Dy | 10 | — | — |
| Example | 132 | Sr_{1.6}Eu_{0.4}Si₇Al₃ON₁₃ | Ho | 0.1 | — | — |
| Example | 133 | Sr_{1.6}Eu_{0.4}Si₇Al₃ON₁₃ | Ho | 1 | — | — |
| Example | 134 | Sr_{1.6}Eu_{0.4}Si₇Al₃ON₁₃ | Ho | 10 | — | — |

TABLE 9

| | | Emission | | Average | |
|---|---|---|---|---|---|
| | | Peak | Luminous | Particle | |
| | Sample | Wavelength | Efficiency | Size D₅₀ | |
| | No. | (nm) | (%) | (μm) | Remarks |
| Compatative | 101 | 620 | 100 | 15 | Non-Eu rare earth element was not added. |
| Example | | | | | |
| Example | 102 | 620 | 100 | 18 | Crystal grain growth was promoted. Luminous efficiency was as normal. |
| Example | 103 | 620 | 102 | 18 | Crystal grain growth was promoted. Luminous efficiency was increased. |
| Example | 104 | 620 | 102 | 17 | Crystal grain growth was promoted. Luminous efficiency was increased. |
| Example | 105 | 620 | 100 | 20 | Crystal grain growth was promoted strongly. Luminous efficiency was increased. |
| Example | 106 | 620 | 110 | 28 | Crystal grain growth was promoted strongly. Luminous efficiency was increased. |
| Example | 107 | 620 | 110 | 29 | Crystal grain growth was promoted strongly. Luminous efficiency was increased. |
| Example | 108 | 620 | 102 | 16 | Luminous efficiency was increased by improving crystalline properties. |
| Example | 109 | 620 | 102 | 16 | Luminous efficiency was increased by improving crystalline properties. |
| Example | 110 | 620 | 102 | 16 | Luminous efficiency was increased by improving crystalline properties. |
| Example | 111 | 620 | 102 | 17 | Luminous efficiency was increased by improving crystalline properties. |
| Example | 112 | 620 | 102 | 18 | Luminous efficiency was increased by improving crystalline properties. |
| Example | 113 | 620 | 102 | 17 | Luminous efficiency was increased by improving crystalline properties. |
| Example | 114 | 620 | 101 | 13 | Luminous efficiency was increased by improving crystalline properties. |
| Example | 115 | 620 | 101 | 15 | Luminous efficiency was increased by improving crystalline properties. |
| Example | 116 | 620 | 101 | 12 | Luminous efficiency was increased by improving crystalline properties. |
| Example | 117 | 620 | 101 | 15 | Luminous efficiency was increased by improving crystalline properties. |
| Example | 118 | 620 | 101 | 15 | Luminous efficiency was increased by improving crystalline properties. |
| Example | 119 | 620 | 101 | 15 | Luminous efficiency was increased by improving crystalline properties. |
| Example | 120 | 620 | 102 | 15 | Luminous efficiency was increased by improving crystalline properties. |
| Example | 121 | 620 | 103 | 15 | Luminous efficiency was increased by improving crystalline properties. |
| Example | 122 | 620 | 103 | 15 | Luminous efficiency was increased by improving crystalline properties. |
| Example | 123 | 620 | 103 | 17 | Luminous efficiency was increased by improving crystalline properties. |
| Example | 124 | 620 | 102 | 17 | Luminous efficiency was increased by improving crystalline properties. |
| Example | 125 | 620 | 104 | 17 | Luminous efficiency was increased by improving crystalline properties. |
| Example | 126 | 620 | 101 | 15 | Luminous efficiency was increased by improving crystalline properties. |
| Example | 127 | 620 | 101 | 14 | Luminous efficiency was increased by improving crystalline properties. |
| Example | 128 | 620 | 101 | 15 | Luminous efficiency was increased by improving crystalline properties. |
| Example | 129 | 620 | 104 | 17 | Luminous efficiency was increased by improving crystalline properties. |
| Example | 130 | 620 | 104 | 17 | Luminous efficiency was increased by improving crystalline properties. |
| Example | 131 | 620 | 104 | 17 | Luminous efficiency was increased by improving crystalline properties. |
| Example | 132 | 620 | 101 | 15 | Luminous efficiency was increased by improving crystalline properties. |
| Example | 133 | 620 | 104 | 13 | Luminous efficiency was increased by improving crystalline properties. |
| Example | 134 | 620 | 103 | 13 | Luminous efficiency was increased by improving crystalline properties. |

TABLE 10

| | | Type and Amount of Blending of Raw Material | | | | | | | |
|---|---|---|---|---|---|---|---|---|---|
| | | | | | | Oxide of Non-Eu | | Oxide of Non-Eu | |
| | | | | | | Rare Earth | | Rare Earth | |
| | | SrCO₃ | AlN | Si₃N₄ | Eu₂O₃ | Element | | Element | |
| | | Amount of | Amount of | Amount of | Amount of | | Amount of | | Amount of |
| | Sample | Blending | Blending | Blending | Blending | | Blending | | Blending |
| | No. | (g) | (g) | (g) | (g) | Type | (g) | Type | (g) |
| Example | 135 | 312 | 162 | 432 | 93 | Er₂O₃ | 1 | — | — |
| Example | 136 | 312 | 162 | 432 | 93 | Er₂O₃ | 11 | — | — |
| Example | 137 | 312 | 162 | 432 | 93 | Er₂O₃ | 114 | — | — |
| Example | 138 | 312 | 162 | 432 | 93 | Tm₂O₃ | 1 | — | — |
| Example | 139 | 312 | 162 | 432 | 93 | Tm₂O₃ | 11 | — | — |
| Example | 140 | 312 | 162 | 432 | 93 | Tm₂O₃ | 114 | — | — |
| Example | 141 | 312 | 162 | 432 | 93 | Yb₂O₃ | 1 | — | — |
| Example | 142 | 312 | 162 | 432 | 93 | Yb₂O₃ | 11 | — | — |
| Example | 143 | 312 | 162 | 432 | 93 | Yb₂O₃ | 114 | — | — |
| Example | 144 | 312 | 162 | 432 | 93 | Lu₂O₃ | 1 | — | — |
| Example | 145 | 312 | 162 | 432 | 93 | Lu₂O₃ | 11 | — | — |
| Example | 146 | 312 | 162 | 432 | 93 | Lu₂O₃ | 114 | — | — |
| Example | 147 | 312 | 162 | 432 | 93 | Y₂O₃ | 13 | La₂O₃ | 12 |
| Example | 148 | 312 | 162 | 432 | 93 | Y₂O₃ | 13 | CeO₂ | 12 |
| Example | 149 | 312 | 162 | 432 | 93 | Y₂O₃ | 13 | Pr₆O₁₁ | 12 |
| Example | 150 | 312 | 162 | 432 | 93 | Y₂O₃ | 13 | Nd₂O₃ | 12 |
| Example | 151 | 312 | 162 | 432 | 93 | Y₂O₃ | 13 | Gd₂O₃ | 12 |
| Example | 152 | 312 | 162 | 432 | 93 | Y₂O₃ | 13 | Lu₂O₃ | 11 |
| Example | 153 | 387 | 150 | 391 | 74 | Y₂O₃ | 13 | — | — |
| Example | 154 | 264 | 166 | 456 | 114 | Y₂O₃ | 13 | — | — |
| Compatative | 161 | 312 | 162 | 432 | 93 | Sc₂O₃ | 230 | — | — |
| Example | | | | | | | | | |
| Compatative | 162 | 312 | 162 | 432 | 93 | Y₂O₃ | 190 | — | — |
| Example | | | | | | | | | |
| Compatative | 163 | 312 | 162 | 432 | 93 | La₂O₃ | 176 | — | — |
| Example | | | | | | | | | |
| Compatative | 164 | 312 | 162 | 432 | 93 | CeO₂ | 184 | — | — |
| Example | | | | | | | | | |
| Compatative | 165 | 312 | 162 | 432 | 93 | Pr₆O₁₁ | 181 | — | — |
| Example | | | | | | | | | |
| Compatative | 166 | 312 | 162 | 432 | 93 | Nd₂O₃ | 175 | — | — |
| Example | | | | | | | | | |
| Compatative | 167 | 312 | 162 | 432 | 93 | Sm₂O₃ | 174 | — | — |
| Example | | | | | | | | | |
| Compatative | 168 | 312 | 162 | 432 | 93 | Gd₂O₃ | 173 | — | — |
| Example | | | | | | | | | |
| Compatative | 169 | 312 | 162 | 432 | 93 | Tb₄O₇ | 176 | — | — |
| Example | | | | | | | | | |
| Compatative | 170 | 312 | 162 | 432 | 93 | Dy₂O₃ | 172 | — | — |
| Example | | | | | | | | | |
| Compatative | 171 | 312 | 162 | 432 | 93 | Ho₂O₃ | 172 | — | — |
| Example | | | | | | | | | |
| Compatative | 172 | 312 | 162 | 432 | 93 | Er₂O₃ | 172 | — | — |
| Example | | | | | | | | | |
| Compatative | 173 | 312 | 162 | 432 | 93 | Tm₂O₃ | 171 | — | — |
| Example | | | | | | | | | |
| Compatative | 174 | 312 | 162 | 432 | 93 | Y₂O₃ | 171 | — | — |
| Example | | | | | | | | | |
| Compatative | 175 | 312 | 162 | 432 | 93 | Lu₂O₃ | 171 | — | — |
| Example | | | | | | | | | |

TABLE 11

| | | | Non-Eu Rare | | Non-Eu Rare | |
|---|---|---|---|---|---|---|
| | | | Earth Element | | Earth Element | |
| | | | contained | | contained | |
| | | | in Baked | | in Baked | |
| | Sample | Basic Composition of Baked | Powder | | Powder | |
| | No. | Powder | Type | (mass %) | Type | (mass %) |
| Example | 135 | Sr_{1.6}Eu_{0.4}Si₇Al₃ON₁₃ | Er | 0.1 | — | — |
| Example | 136 | Sr_{1.6}Eu_{0.4}Si₇Al₃ON₁₃ | Er | 1 | — | — |
| Example | 137 | Sr_{1.6}Eu_{0.4}Si₇Al₃ON₁₃ | Er | 10 | — | — |
| Example | 138 | Sr_{1.6}Eu_{0.4}Si₇Al₃ON₁₃ | Tm | 0.1 | — | — |
| Example | 139 | Sr_{1.6}Eu_{0.4}Si₇Al₃ON₁₃ | Tm | 1 | — | — |
| Example | 140 | Sr_{1.6}Eu_{0.4}Si₇Al₃ON₁₃ | Tm | 10 | — | — |
| Example | 141 | Sr_{1.6}Eu_{0.4}Si₇Al₃ON₁₃ | Yb | 0.1 | — | — |
| Example | 142 | Sr_{1.6}Eu_{0.4}Si₇Al₃ON₁₃ | Yb | 1 | — | — |
| Example | 143 | Sr_{1.6}Eu_{0.4}Si₇Al₃ON₁₃ | Yb | 10 | — | — |
| Example | 144 | Sr_{1.6}Eu_{0.4}Si₇Al₃ON₁₃ | Lu | 0.1 | — | — |
| Example | 145 | Sr_{1.6}Eu_{0.4}Si₇Al₃ON₁₃ | Lu | 1 | — | — |
| Example | 146 | Sr_{1.6}Eu_{0.4}Si₇Al₃ON₁₃ | Lu | 10 | — | — |
| Example | 147 | Sr_{1.6}Eu_{0.4}Si₇Al₃ON₁₃ | Y | 1 | La | 1 |
| Example | 148 | Sr_{1.6}Eu_{0.4}Si₇Al₃ON₁₃ | Y | 1 | Ce | 1 |
| Example | 149 | Sr_{1.6}Eu_{0.4}Si₇Al₃ON₁₃ | Y | 1 | Pr | 1 |
| Example | 150 | Sr_{1.6}Eu_{0.4}Si₇Al₃ON₁₃ | Y | 1 | Nd | 1 |
| Example | 151 | Sr_{1.6}Eu_{0.4}Si₇Al₃ON₁₃ | Y | 1 | Gd | 1 |
| Example | 152 | Sr_{1.6}Eu_{0.4}Si₇Al₃ON₁₃ | Y | 1 | Lu | 1 |
| Example | 153 | Sr_{2.5}Eu_{0.4}Si₈Al_{3.5}ON₁₃ | Y | 1 | — | — |
| Example | 154 | Sr_{1.1}Eu_{0.4}Si₆Al_{2.5}ON₁₃ | Y | 1 | — | — |
| Compatative | 161 | Sr_{1.6}Eu_{0.4}Si₇Al₃ON₁₃ | Sc | 15 | — | — |
| Example | | | | | | |
| Compatative | 162 | Sr_{1.6}Eu_{0.4}Si₇Al₃ON₁₃ | Y | 15 | — | — |
| Example | | | | | | |
| Compatative | 163 | Sr_{1.6}Eu_{0.4}Si₇Al₃ON₁₃ | La | 15 | — | — |
| Example | | | | | | |
| Compatative | 164 | Sr_{1.6}Eu_{0.4}Si₇Al₃ON₁₃ | Ce | 15 | — | — |
| Example | | | | | | |
| Compatative | 165 | Sr_{1.6}Eu_{0.4}Si₇Al₃ON₁₃ | Pr | 15 | — | — |
| Example | | | | | | |
| Compatative | 166 | Sr_{1.6}Eu_{0.4}Si₇Al₃ON₁₃ | Nd | 15 | — | — |
| Example | | | | | | |
| Compatative | 167 | Sr_{1.6}Eu_{0.4}Si₇Al₃ON₁₃ | Sm | 15 | — | — |
| Example | | | | | | |
| Compatative | 168 | Sr_{1.6}Eu_{0.4}Si₇Al₃ON₁₃ | Gd | 15 | — | — |
| Example | | | | | | |
| Compatative | 169 | Sr_{1.6}Eu_{0.4}Si₇Al₃ON₁₃ | Tb | 15 | — | — |
| Example | | | | | | |
| Compatative | 170 | Sr_{1.6}Eu_{0.4}Si₇Al₃ON₁₃ | Dy | 15 | — | — |
| Example | | | | | | |
| Compatative | 171 | Sr_{1.6}Eu_{0.4}Si₇Al₃ON₁₃ | Ho | 15 | — | — |
| Example | | | | | | |
| Compatative | 172 | Sr_{1.6}Eu_{0.4}Si₇Al₃ON₁₃ | Er | 15 | — | — |
| Example | | | | | | |
| Compatative | 173 | Sr_{1.6}Eu_{0.4}Si₇Al₃ON₁₃ | Tm | 15 | — | — |
| Example | | | | | | |
| Compatative | 174 | Sr_{1.6}Eu_{0.4}Si₇Al₃ON₁₃ | Yb | 15 | — | — |
| Example | | | | | | |
| Compatative | 175 | Sr_{1.6}Eu_{0.4}Si₇Al₃ON₁₃ | Lu | 15 | — | — |
| Example | | | | | | |

TABLE 12

| | | Emission | | Average | |
|---|---|---|---|---|---|
| | | Peak | Luminous | Particle | |
| | Sample | Wavelength | Efficiency | Size D₅₀ | |
| | No | (nm) | (%) | (μm) | Remarks |
| Example | 135 | 620 | 103 | 15 | Luminous efficiency was increased by improving crystalline properties. |
| Example | 136 | 620 | 103 | 15 | Luminous efficiency was increased by improving crystalline properties. |
| Example | 137 | 620 | 103 | 15 | Luminous efficiency was increased by improving crystalline properties. |
| Example | 138 | 620 | 101 | 16 | Luminous efficiency was increased by improving crystalline properties. |
| Example | 139 | 620 | 101 | 16 | Luminous efficiency was increased by improving crystalline properties. |
| Example | 140 | 620 | 101 | 15 | Luminous efficiency was increased by improving crystalline properties. |
| Example | 141 | 620 | 102 | 17 | Luminous efficiency was increased by improving crystalline properties. |
| Example | 142 | 620 | 102 | 18 | Luminous efficiency was increased by improving crystalline properties. |
| Example | 143 | 620 | 101 | 19 | Luminous efficiency was increased by improving crystalline properties. |
| Example | 144 | 620 | 104 | 17 | Crystal grain growth was promoted. Luminous efficiency was increased. |
| Example | 145 | 620 | 106 | 22 | Crystal grain growth was promoted. Luminous efficiency was increased. |
| Example | 146 | 620 | 106 | 24 | Crystal grain growth was promoted. Luminous efficiency was increased. |
| Example | 147 | 620 | 110 | 30 | Crystal grain growth was promoted strongly. Luminous efficiency was increased. |
| Example | 148 | 620 | 112 | 31 | Crystal grain growth was promoted strongly. Luminous efficiency was increased. |
| Example | 149 | 620 | 113 | 32 | Crystal grain growth was promoted strongly. Luminous efficiency was increased. |
| Example | 150 | 620 | 115 | 30 | Crystal grain growth was promoted strongly. Luminous efficiency was increased. |
| Example | 151 | 620 | 110 | 28 | Crystal grain growth was promoted strongly. Luminous efficiency was increased. |
| Example | 152 | 620 | 113 | 30 | Crystal grain growth was promoted strongly. Luminous efficiency was increased. |
| Example | 153 | 620 | 112 | 26 | Crystal grain growth was promoted strongly. Luminous efficiency was increased. |
| Example | 154 | 620 | 110 | 32 | Crystal grain growth was promoted strongly. Luminous efficiency was increased. |
| Compatative | 161 | 620 | 80 | 17 | Luminous efficiency was decreased by containing impurrties. |
| Example | | | | | |
| Compatative | 162 | 620 | 90 | 30 | Luminous efficiency was decreased by containing impurrties. |
| Example | | | | | |
| Compatative | 163 | 620 | 76 | 20 | Luminous efficiency was decreased by containing impurrties. |
| Example | | | | | |
| Compatative | 164 | 620 | 78 | 20 | Luminous efficiency was decreased by containing impurrties. |
| Example | | | | | |
| Compatative | 165 | 620 | 65 | 20 | Luminous efficiency was decreased by containing impurrties. |
| Example | | | | | |
| Compatative | 166 | 620 | 67 | 25 | Luminous efficiency was decreased by containing impurrties. |
| Example | | | | | |
| Compatative | 167 | 620 | 67 | 14 | Luminous efficiency was decreased by containing impurrties. |
| Example | | | | | |
| Compatative | 168 | 620 | 60 | 16 | Luminous efficiency was decreased by containing impurrties. |
| Example | | | | | |
| Compatative | 169 | 620 | 70 | 16 | Luminous efficiency was decreased by containing impurrties. |
| Example | | | | | |
| Compatative | 170 | 620 | 72 | 16 | Luminous efficiency was decreased by containing impurities. |
| Example | | | | | |
| Compatative | 171 | 620 | 74 | 16 | Luminous efficiency was decreased by containing impurrties. |
| Example | | | | | |
| Compatative | 172 | 620 | 70 | 16 | Luminous efficiency was decreased by containing impurrties. |
| Example | | | | | |
| Compatative | 173 | 620 | 70 | 16 | Luminous efficiency was decreased by containing impurrties. |
| Example | | | | | |
| Compatative | 174 | 620 | 69 | 15 | Luminous efficiency was decreased by containing impurrties. |
| Example | | | | | |
| Compatative | 175 | 620 | 82 | 16 | Luminous efficiency was decreased by containing impurrties. |
| Example | | | | | |

Table 1 to Table 12 show that when the content of the non-Eu rare earth element in the phosphor is in a specific range, the phosphor has improved luminous efficiency as compared to a phosphor free of non-Eu rare earth elements or a phosphor containing an excessive amount of a non-Eu rare earth element.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

In Examples described above, a phosphor and a light emitting device with high luminous efficiency are prepared.

1. A phosphor comprising a europium-activated sialon crystal having a basic composition represented by the following formula (1)
[Formula 1]
formula: (Sr₁₋ₓ, Euₓ)_{α}Si_{β}Al_{γ}O_{δ}N_{ω} (1)
(wherein x is 0<x<1, α is 0<α≦4 and β, γ, δ and ω are numbers such that converted numerical values when α is 3 satisfy 9<β≦15, 1≦γ≦5, 0.5≦δ≦3 and 10≦ω≦25), and the sialon crystal includes at least one non-Eu rare earth element selected from Sc, Y, La, Ce, Pr, Nd, Sm, Gd, Tb, Dy, Ho, Er, Tm, Yb and Lu in a proportion of 0.1% by mass or more and 10% by mass or less,
and the phosphor emitting green light by being excited by ultraviolet light, violet light or blue light.

2. A phosphor comprising a europium-activated sialon crystal having a basic composition represented by the following formula (2)
[Formula 2]
formula: (Sr₁₋ₓ, Euₓ)_{α}Si_{β}Al_{γ}O_{δ}N_{ω} (2)
(wherein x is 0<x<1, α is 0<α≦3 and β, γ, δ and ω are numbers such that the converted numerical values when α is 2 satisfy 5≦β≦9, 1≦γ≦5, 0.5≦δ≦2 and 5≦ω≦15),
and the sialon crystal includes at least one non-Eu rare earth element selected from Sc, Y, La, Ce, Pr, Nd, Sm, Gd, Tb, Dy, Ho, Er, Tm, Yb and Lu in a proportion of 0.1% by mass or more and 10% by mass or less,
and the phosphor emitting red light by being excited by ultraviolet light, violet light or blue light.

3. The phosphor according to claim 1, wherein the ultraviolet light, violet light or blue light has a peak wavelength in a range of 370 nm or more and 470 nm or less.

4. The phosphor according to claim 1, having an average particle size of 1 μm or more and 100 μm or less.

5. The green light-emitting phosphor according to claim 1, having an emission peak wavelength of 500 nm or more and 540 nm or less.

6. The yellow to red light-emitting phosphor according to claim 2, having an emission peak wavelength of 550 nm or more and 650 nm or less.

7. A light emitting device comprising:
a substrate,
a semiconductor light emitting element which is arranged on the substrate and emits ultraviolet light, violet light or blue light, and
a light emitting portion which is formed so as to cover a light emitting surface of the semiconductor light emitting element and contains a phosphor which emits visible light by being excited by light emitted from the semiconductor light emitting element,
wherein the phosphor includes a phosphor according to claim 1.

8. The light emitting device according to claim 7,
wherein the semiconductor light emitting element is a light-emitting diode or a laser diode which emits light having a peak wavelength in a range of 370 nm or more and 470 nm or less.
